(19) United States
(12) Patent Application Publication
(10) Pub. No.: US 2017/0064661 A1
(43) Pub. Date: Mar. 2, 2017

(54) BASE STATION SYSTEM, RADIO DEVICE AND METHOD

(71) Applicant: FUJITSU LIMITED, Kawasaki-shi (JP)

(72) Inventors: Yuichiro KATAGIRI, Inagi (JP); Shigeaki Kawamata, Sagamihara (JP); Kenji Kazehaya, Yokohama (JP); Masumi Kobayashi, Kawasaki (JP)

(21) Appl. No.: 15/231,088

(22) Filed: Aug. 8, 2016

(30) Foreign Application Priority Data
Sep. 2, 2015 (JP) 2015-173121

(51) Int. Cl. H04W 56/00

(52) U.S. Cl. CPC H04W 56/0045; H04W 56/001; H04W 88/08

(57) ABSTRACT

A base station system includes a radio control device and a radio device, the radio control device transmits first time information and data to the radio device, the radio device includes an antenna and is configured to receive the first time information and the data generate second time information synchronized with the first time information based on the first time information, store the data into a buffer, identify, based on the second time information, a first timing when the data is to be transmitted from the antenna, identify, based on a difference between the first timing and a second timing specified based on a system clock recovered from the received data, a third timing when the data is to be read from the buffer, read the data stored in the buffer at the identified third timing, and control the antenna to transmit the data read from the buffer.

### CROSS-REFERENCE TO RELATED APPLICATION

This application is based upon and claims the benefit of priority of the prior Japanese Patent Application No. 2015-173121, filed on Sep. 2, 2015, the entire contents of which are incorporated herein by reference.

### FIELD

The embodiment discussed herein is related to a base station system, a radio device and a method.

### BACKGROUND

Conventionally, there has been known a technique to time synchronize communication devices on the subscriber side in a passive optical network (PON). There has also been known a technique to perform clock synchronization between a master apparatus and a slave apparatus in a network server system for securities transactions or a factory automation (FA) system. In addition, there has been known a technique to synchronize radio frames at multiple antenna terminals. Conventionally, there has also been known a configuration to implement a base station device, for example, in cellular communications, with a configuration in which a baseband processing unit to perform baseband processing and the like and radio units to transmit and receive radio signals are provided as separate units. The related art documents include Japanese Laid-open Patent Publication Nos. 2009-5070, 2011-124759, 2014-146877, and 2010-226460.

### SUMMARY

According to an aspect of the invention, a base station system includes a radio control device that performs baseband processing, and a radio device that is coupled to the radio control device through a transmission path, wherein the radio control device includes a first memory, and a first processor coupled to the first memory and configured to transmit first time information and data to the radio device, the radio device includes an antenna, a second memory, and a second processor coupled to the second memory and configured to receive the first time information and the data, generate second time information synchronized with the first time information based on the first time information transmitted from the radio control device, store the data into a buffer, identify, based on the second time information, a first timing when the data is to be transmitted from the antenna, identify, based on a difference between the first timing and a second timing specified based on a system clock recovered from the received data, a third timing when the data is to be read from the buffer, read the data stored in the buffer at the identified third timing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a base station system according to an embodiment.

FIG. 2 is a diagram illustrating an example of sharing a delay correction between an REC and REs according to the embodiment.

FIG. 3 is a diagram (part 1) illustrating an example of a CPRI frame applicable to the embodiment.

FIG. 4 is a diagram (part 2) illustrating the example of the CPRI frame applicable to the embodiment.

FIG. 5 is a diagram (part 3) illustrating the example of the CPRI frame applicable to the embodiment.

FIG. 6 is a diagram illustrating an example of a delay correction unit of an RE according to the embodiment.

FIG. 7 is a diagram illustrating an example of delay correction processing by the RE according to the embodiment.

FIG. 8 is a diagram illustrating an example of a CPRI terminal unit according to the embodiment.

FIG. 9 is a sequence diagram illustrating an example of PTP processing according to the embodiment.

FIG. 10 is a diagram illustrating an example of impartation of delay information by an in-device switch according to the embodiment.

FIG. 11 is a diagram illustrating an example of a SYNC/CLK processing unit according to the embodiment.

FIG. 12 is a diagram illustrating an example of PTP slave operation in the RE according to the embodiment.

FIG. 13 is a diagram illustrating an example of variation in in-device delay time in the CPRI terminal unit according to the embodiment.

FIG. 14 is a diagram illustrating another example of the CPRI terminal unit according to the embodiment.

FIG. 15 is a flowchart illustrating an example of transmission processing by the CPRI terminal unit according to the embodiment.

FIG. 16 is a flowchart illustrating an example of reception processing by the CPRI terminal unit according to the embodiment.

FIG. 17 is a diagram illustrating an example of notification of a transmission timing according to the embodiment.

FIG. 18 is a flowchart illustrating an example of the PTP processing with a boundary clock performed by the RE according to the embodiment.

FIG. 19 is a sequence diagram illustrating an example of the PTP processing with the boundary clock performed by the base station system according to the embodiment.

FIG. 20 is a flowchart illustrating an example of the PTP processing with a transparent clock performed by the RE according to the embodiment.

FIG. 21 is a sequence diagram illustrating an example of the PTP processing with the transparent clock performed by the base station system according to the embodiment.

FIG. 22 is a diagram illustrating an example of a coupling method for the REs according to the embodiment.

FIG. 23 is a diagram illustrating another example of the coupling method for the RE according to the embodiment.

FIG. 24 is a diagram illustrating another example of the base station system according to the embodiment.

### DESCRIPTION OF EMBODIMENT

The conventional techniques described above has a problem that, for example, when delay time of data transmission from the baseband processing unit to the radio unit varies among the radio units, it is not possible to bring the timings of the radio units wirelessly transmitting data into coincidence with each other.

Referring to the drawings, detailed descriptions are hereinafter provided for an embodiment of a radio device and a base station system according to the disclosure.

### Embodiment

### Base Station System According to Embodiment

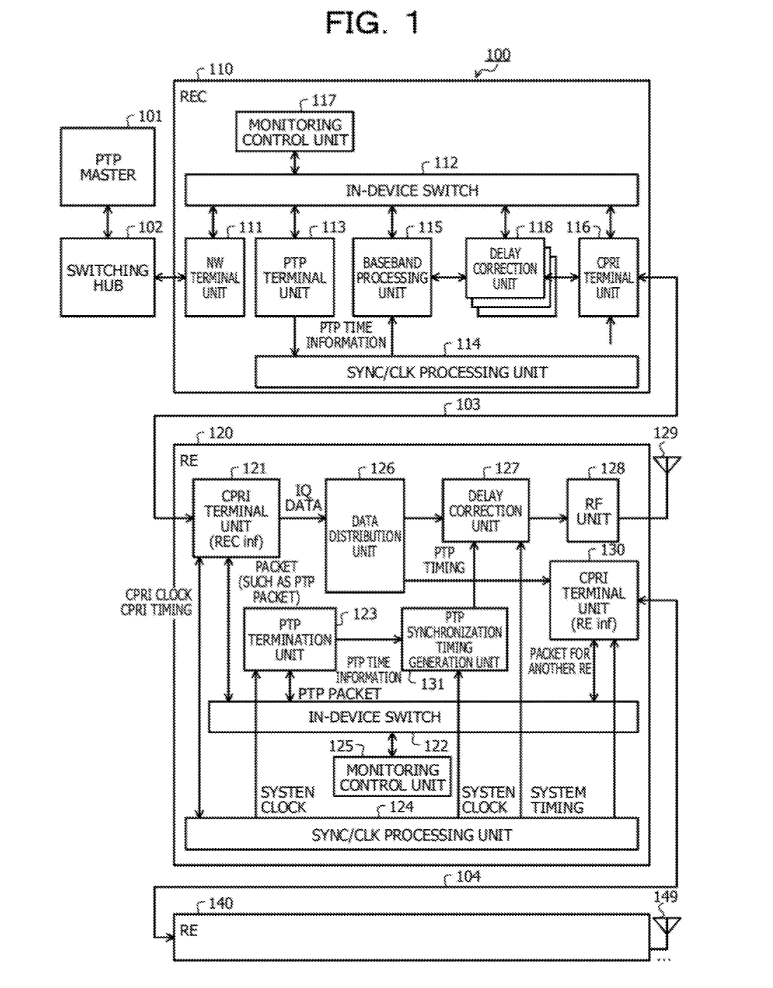

FIG. 1 is a diagram illustrating an example of a base station system according to the embodiment. As illustrated in FIG. 1, the base station system 100 according to the embodiment is a radio base station device including an REC 110, REs 120, 140, and so on. Note that REC stands for a Radio Equipment Control and RE stands for Radio Equipment. A PTP master 101 illustrated in FIG. 1 is a communication device including a master function for a precision time protocol (PTP). The PIP is a PTP defined in the IEEE1588, as an example. A switching hub 102 is a hub that couples devices including the PTP master 101 and the REC 110 and is configured to perform switching of communications between the devices.

In the example illustrated in FIG. 1, the REs 120, 140, and so on are coupled to the REC 110 in a cascading manner. For example, the RE 120 is coupled to the REC 110 through a CPRI transmission path 103. Note that CPRI stands for Common Public Radio Interface. The RE 140 is coupled to the REC 110 through a CPRI transmission path 104, the RE 120, and the CPRI transmission path 103. The CPRI transmission paths 103 and 104 are transmission paths using a communication interface such as an optical line, for example. Moreover, another RE may be coupled to the RE 140.

The REC 110 is a radio control devices including a baseband processing unit configured to perform digital baseband signal processing, terminal processing for an S1 line used for coupling with a core network, terminal processing for an X2 line used for coupling with a neighboring eNB, and other processing. The REC 110 also performs call processing and various kinds of monitoring control processing. The REC 110 is a baseband device called a Base Band Unit (BBU) or Baseband Digital Equipment (BDE), for example.

For example, the REC 110 modulates an IP packet received from a core network into a digital baseband signal and transmits the modulated signal to the REs 120, 140, and so on. The REC 110 also demodulates a digital baseband signal received from the REs 120, 140, and so on, and transmits an IP packet obtained by the demodulation to the core network.

The REs 120, 140, and so on are radio units coupled to the REC 110 through the CPRI transmission path 103 and configured to transmit and receive a radio signal under control of the REC 110. Each of the REs 120, 140, and so on is a radio device called a Remote RE (RRE), a Remote Radio Head (RRH), or a Radio Head (RH), for example.

For example, the RE 120 converts the digital baseband signal transmitted from the REC 110 into an analog radio frequency (RF: high frequency) signal, amplifies the converted RF signal, and wirelessly transmits the amplified RF signal to a radio terminal or the like. The RE 120 also amplifies an RF signal received from the radio terminal or the like, converts the amplified signal into a digital baseband signal, and transmits the converted digital baseband signal to the REC 110.

The RE 140 converts the digital baseband signal transmitted from the REC 110 through the RE 120 into an analog RF signal, amplifies the converted RF signal, and wirelessly transmits the amplified RF signal to a radio terminal or the like. The RE 140 also amplifies an RF signal received from the radio terminal or the like, converts the amplified signal into a digital baseband signal, and transmits the converted digital baseband signal to the REC 110 through the CPRI transmission path 104, the RE 120, and the CPRI transmission path 103.

The REC 110 includes, for example, a NW terminal unit 111, an in-device switch 112, a PTP terminal unit 113, a SYNC/CLK processing unit 114, a baseband processing unit 115, a CPRI terminal unit 116, a monitoring control unit 117, and delay correction units 118. The NW terminal unit 111, coupled to the switching hub 102, is a communication interface that transmits and receives various kinds of packets to and from a host network including the PTP master 101.

The in-device switch 112 is a switch that performs switching of packets transmitted and received between these processing units included in the REC 110. For example, the in-device switch 112 is coupled to the NW terminal unit 111, the PTP terminal unit 113, the baseband processing unit 115, the CPRI terminal unit 116, the monitoring control unit 117, and the delay correction units 118, and performs switching of packets transmitted and received between these units. In the case where the PTP processing with the transparent clock is performed between the REC 110 and REs 120, 140, and so on, the in-device switch 112 may impart delay information based on a delay inside the in-device switch 112, on a packet for the REs 120, 140, and so on.

The PTP terminal unit 113 transmits and receives a PTP packet (a synchronization signal) in the PTP processing. For example, when time synchronization is performed using PTP between the PTP master 101 and the REC 110, the PTP terminal unit 113 serves as a PTP slave. In this case, the PTP terminal unit 113 performs the time synchronization by transmitting and receiving the PTP packet to and from the PTP master 101.

In the case where the PTP processing (boundary clock) is performed between the REC 110 and the REs 120, 140, and so on, the PTP terminal unit 113 serves as the PTP master. In this case, the PTP terminal unit 113 brings the RE 120 in time synchronization with the REC 110 by transmitting and receiving the PTP packet to and from the RE 120. The PTP terminal unit 113 in this case operates based on the time (system clock and system timing) according to the REC 110, which is in time synchronization with the PTP master 101.

The SYNC/CLK processing unit 114 generates the system clock and the system timing based on PTP time information (current time information of the PTP slave in synchronization with the PTP master) acquired by the PTP terminal unit 113 through the PTP transmission with the PTP master 101. The system clock is a clock signal serving as a reference of the operation frequency of each processing unit included in the REC 110. The system timing is time information such as a frame number serving as a reference of operation timings of each processing unit included in the REC 110. For example, the SYNC/CLK processing unit 114 may generate a system frame number (SFN), which is a system timing, by performing a predetermined remainder operation using the PTP time information. As a predetermined remainder operation, for example, a formula: SFN={(PTP seconds−315964819)×100} mod 1024 may be used. In this example, “SFN” indicates a frame number that has a cycle of 10.24 seconds and increments of 10 [ms], starting 0 hours 0 minutes 0 seconds, Jan. 6, 1980. “PTP seconds” indicates an accumulated number of seconds since 0 hours 0 minutes 0 seconds, Jan. 1, 1970 (TAI). Note that the value “315964819” is the difference (seconds) between “0 hours 0 minutes 0 seconds, Jan. 6, 1980 (UTC)”, which is the start point of the time information in GPS, and the start point of the PTP time information. In other words, the 315964819 seconds means the sum of the number of seconds for 10 years and 5 days and the difference (19 seconds) between UTC and TAI is. The value “1024” is a value depending on the maximum value of SFN, and SFN in this example is an integer from 0 to 1023.

The baseband processing unit 115 performs baseband processing on the data to be wirelessly transmitted by the REs 120, 140, and so on and the data wirelessly received by the REs 120, 140, and so on. For example, the baseband processing unit 115 outputs IQ data (data frame) to be wirelessly transmitted by the REs 120, 140, and so on to the delay correction units 118 based on the system clock and the system timing from the SYNC/CLK processing unit 114.

An example of the IQ data, which the baseband processing unit 115 outputs to the delay correction units 118 is an ether frame of Ethernet. Note that Ethernet is a registered trademark.

To adjust timings (output timings at antennas) of wireless transmission by the REs 120, 140, and so on, the delay correction units 118 perform a delay correction to the IQ data outputted from the baseband processing unit 115 and to be transmitted by the CPRI terminal unit 116. The delay correction units 118 perform the delay correction, for example, by storing the IQ data in a buffer to add a delay. The delay correction units 118 are provided, one for each of the REs 120, 140, and so on, and perform the delay correction of the IQ data for each RE, which is the destination of the transmission.

The CPRI terminal unit 116 is a communication Interface that terminates communications through the CPRI transmission path 103 to the subordinate RE 120. For example, the CPRI terminal unit 116 converts the IQ data outputted from the delay correction units 118 into a CPRI frame, and transmits the converted CPRI frame to the RE120 through the CPRI transmission path 103.

The CPRI terminal unit 116 transmits the CPRI frame in synchronization with the system clock and the system timing from the SYNC/CLK processing unit 114. In the case where the PTP processing with the transparent clock is performed between the REC 110 and the REs 120, 140, and so on, the CPRI terminal unit 116 may include a function of imparting time information indicating transmission and reception time of the PTP packet.

The monitoring control unit 117 performs monitoring control for the inside of the REC 110. The monitoring control unit 117 also communicates with the REs 120, 140, and so on, and host devices of the REC 110. The host devices of the REC 110 are control devices, for example, various kinds of gateways and a mobility management entity (MME) on the core network with which the REC 110 is coupled.

The NW terminal unit 111 and the CPRI terminal unit 116 may be implemented using a communication interface based on each corresponding communication standard. The in-device switch 112, the PTP terminal unit 113, the SYNC/CLK processing unit 114, the baseband processing unit 115, and the delay correction units 118 are implemented, for example, with digital circuits. For the digital circuits, various kinds of circuits such as a digital signal processor (DSP) or a field programmable gate array (FPGA) may be used. The monitoring control unit 117 may be implemented, for example, using a central processing unit (CPU).

Although a description is provided for a configuration of the RE 120 next, the RE 140 also has the same configuration. The RE 120 includes a CPRI terminal unit 121, an in-device switch 122, a PTP terminal unit 123, a SYNC/CLK processing unit 124, a monitoring control unit 125, a data distribution unit 126, a delay correction unit 127, an RF unit 128, and an antenna 129. The RE 120 also includes a CPRI terminal unit 130 and a PTP synchronization timing generation unit 131.

The CPRI terminal unit 121 (REC inf) is a communication interface that terminates communications through the CPRI transmission path 103 to the REC 110. For example, the CPRI terminal unit 121 receives the CPRI frame transmitted from the REC 110 through CPRI transmission path 103. Then, the CPRI terminal unit 121 outputs the IQ data included in the received CPRI frame to the data distribution unit 126. The CPRI terminal unit 121 also outputs other packets included in the received CPRI frame to the in-device switch 122.

In addition, the CPRI terminal unit 121 reproduces a clock (CPRI clock) from the received CPRI frame. The CPRI clock is a clock in frequency synchronization with the system clock of the REC 110. The CPRI terminal unit 121 also extracts a timing (CPRI timing) of the received CPRI frame based on the reproduced CPRI clock. The CPRI timing is a timing in timing synchronization with the system timing of the REC 110. The CPRI timing is, for example, a frame number. The CPRI terminal unit 121 outputs the acquired CPRI frame and CPRI timing to the SYNC/CLK processing unit 124.

In the case where the PTP processing with the transparent clock is performed between the REC 110 and the REs 120, 140, and so on, the CPRI terminal unit 121 may include a function of imparting time information indicating transmission or reception time of the PTP packet.

The in-device switch 122 is a switch that performs switching of the packets transmitted and received between these processing units included in the RE 120. For example, the in-device switch 112 is coupled to the CPRI terminal unit 121, the PTP terminal unit 123, the monitoring control unit 125, and the CPRI terminal unit 130, and performs switching of the packets transmitted and received between these units.

For example, the in-device switch 122 outputs the PTP packet included in the packets outputted from the CPRI terminal unit 121, to the PTP terminal unit 123. The in-device switch 122 also outputs packets destined for other REs (for example, RE 140) included in the packets outputted from the CPRI terminal unit 121, to the CPRI terminal unit 130. In the case where the PTP processing with the transparent clock is performed between the REC 110 and the REs 120, 140, and so on, the in-device switch 122 may impart time information based on a delay inside the in-device switch 122, on the packets for the RE 140, and so on.

The PTP terminal unit 123 transmits and receives the PTP packet in PTP processing. For example, when the time synchronization using PTP is performed between the REC 110 and the RE 120, the PTP terminal unit 123 serves as the PTP slave. In this case, the PTP terminal unit 123 performs the time synchronization by transmitting and receiving the PTP packet to and from the PTP terminal unit 113 of the REC 110. In this case, the PTP packet is a synchronization signal for the RE 120 to come into time synchronization with the REC 110.

In the case where the PTP processing with a boundary clock is performed between the REC 110 and REs 120, 140, and so on, the PTP terminal unit 123 serves as the PTP master to the RE 140 in the subsequent stage. In this case, the PTP terminal unit 123 performs the time synchronization by transmitting and receiving the PTP packet to and from the RE 140, and so on. When the PTP packet from the REC 110 is outputted from the in-device switch 122, the PTP terminal unit 123 acquires the PTP time information indicating the time of the REC 110 from the outputted PTP packet, and outputs the acquired PTP time Information to the PTP synchronization timing generation unit 131.

The SYNC/CLK processing unit 124 uses the CPRI clock and the CPRI timing outputted from the CPRI terminal unit 121 as the system clock and the system timing of RE 120. For example, the SYNC/CLK processing unit 124 outputs the system clock and the system timing to each processing unit in the RE 120 as a system clock and a system timing in synchronization with the CPRI clock and the CPRI timing outputted from the CPRI terminal unit 121.

The PTP synchronization timing generation unit 131 generates a PTP timing (SFN in synchronization with the REC 110, which is the PTP master) which indicates a timing for the RE 120 to wirelessly transmit and which is based on the PTP time information (the current time information of the PTP slave in synchronization with the PTP master) outputted from the PTP terminal unit 123. Then, the PTP synchronization timing generation unit 131 outputs the generated PTP timing to the delay correction unit 127. For example, PTP synchronization timing generation unit 131 may generate the PTP timing by performing a predetermined remainder operation using the PTP time information. As a predetermined remainder operation, for example, a formula: PTP timing={(PTP seconds−315964819)×100} mod 1024 may be used. In this example, “PTP seconds” indicates an accumulated number of seconds since 0 hours 0 minutes 0 seconds, Jan. 1, 1970 (TAI). The value “315964819” is the difference (seconds) between “0 hours 0 minutes 0 seconds, Jan. 6, 1980 (UTC)”, which is the start point of the time information in GPS, and the start point of the PTP time information. The value “1024” is a value depending on the upper limit value of SFN, and SFN in this example is an integer from 0 to 1023.

For example, the PTP synchronization timing generation unit 131 generates the PTP timing, which is in timing synchronization with the timing indicated by the PTP time information from the SYNC/CLK processing unit 124, by using the system clock of the RE 120 from the SYNC/CLK processing unit 124. This makes it possible to generate the PTP timing in time synchronization with the REC 110 without receiving the PTP time information from the REC 110 all the time.

The monitoring control unit 125 performs monitoring control for the inside of the RE 120. For example, the monitoring control unit 125 performs various controls of the RE 120 by transmitting and receiving packets for the controls to and from the REC 110.

The data distribution unit 126 distributes the IQ data outputted from the CPRI terminal unit 121, to each processing unit. For example, out of the IQ data outputted from the CPRI terminal unit 121, the data distribution unit 126 outputs the IQ data to be wirelessly transmitted by the RE 120, to the delay correction unit 127. In addition, out of the IQ data outputted from the CPRI terminal unit 121, the data distribution unit 126 outputs the IQ data (for other REs) to be wirelessly transmitted by other REs (for example, the RE 140), to the CPRI terminal unit 130.

The delay correction unit 127 performs a delay correction to the IQ data outputted from the data distribution unit 126 such that the IQ data are wirelessly transmitted from the RE 120 at the PTP timing outputted from the PTP synchronization timing generation unit 131. For example, the delay correction unit 127 performs the delay correction (delay adjustment) based on the PTP timing outputted from the PTP synchronization timing generation unit 131 and the system timing outputted from the SYNC/CLK processing unit 124.

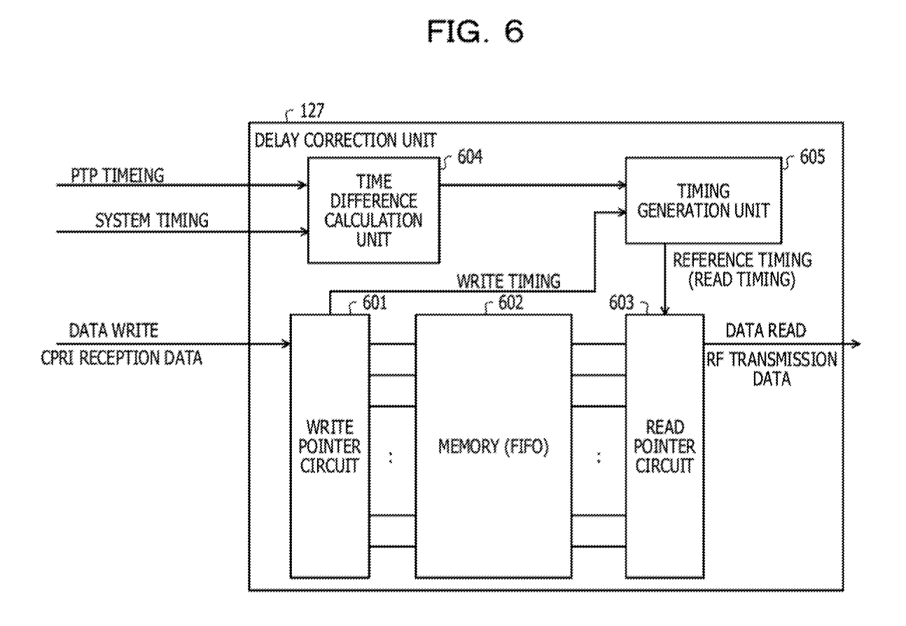

This makes it possible for the delay correction unit 127 to perform the delay correction to the IQ data to be wirelessly transmitted by the RE 120 such that the transmission timing is matched with the PTP timing based on the PTP processing. The delay correction by the delay correction unit 127 is described later (see FIG. 6, for example). The delay correction unit 127 outputs the IQ data to which the delay correction is performed, to the RF unit 128.

The RF unit 128 wirelessly transmits the IQ data outputted from the delay correction unit 127 through the antenna 129. For example, the RF unit 128 includes a digital/analog converter (DAC), a frequency convertor, and an amplifier. The DAC converts the IQ data from a digital signal to an analog signal. The frequency convertor converts the IQ data from a baseband frequency to a high frequency. The amplifier amplifies the IQ data.

The CPRI terminal unit 130 (RE inf) is used in the case where the subordinate RE 140 is present under the RE 120. In other words, the CPRI terminal unit 130 is a communication interface that terminates communications through the CPRI transmission path 104 to the subordinate RE 140. For example, the CPRI terminal unit 130 converts the IQ data outputted from the data distribution unit 126 and packets for other REs (for example, the RE 140) outputted from the in-device switch 122, into a CPRI frame. The CPRI terminal unit 130 transmits the CPRI frame obtained from the conversion to the RE 140 through the CPRI transmission path 104.

The CPRI terminal unit 130 transmits the CPRI frame in synchronization with the system clock and the system timing from the SYNC/CLK processing unit 124. In the case where the PTP processing with the transparent clock is performed between the REC 110 and the REs 120, 140, and so on, the CPRI terminal unit 130 may include a function of imparting the time information indicating transmission and reception time of the PTP packet.

The CPRI terminal units 121 and 130 may be implemented using a communication interface based on each corresponding communication standard. The in-device switch 122, the PTP terminal unit 123, the SYNC/CLK processing unit 124, the data distribution unit 126, the delay correction unit 127, and the PTP synchronization timing generation unit 131 may be implemented, for example, with digital circuits. For the digital circuits, various kinds of circuits such as a DSP or a FPGA may be used. The monitoring control unit 125 may be implemented, for example, using a CPU. The RF unit 128 may be implemented, for example, with a DAC and analog circuits such as a frequency converter and an amplifier.

(Sharing Delay Correction Between REC and RE According to Embodiment)

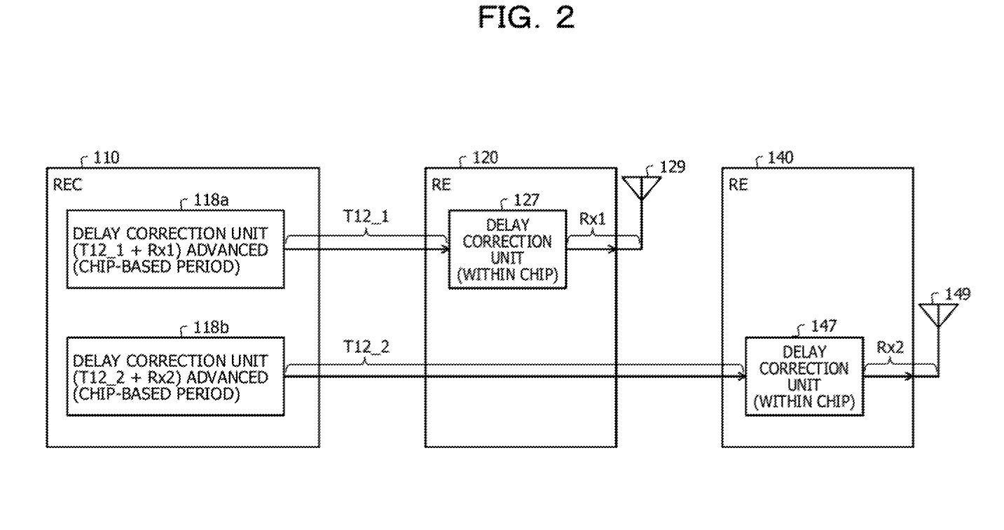

FIG. 2 is a diagram illustrating an example of sharing the delay correction between the REC and the REs according to the embodiment. In FIG. 2, the same units as those in FIG. 1 are denoted by the same reference signs, and descriptions thereof are omitted.

A delay time T12_1 illustrated in FIG. 2 is a delay time of the transmission between the REC 110 and the RE 120. The delay time Rx1 is a delay time (in-device delay time) of the transmission between the delay correction unit 127 of the RE 120 and the antenna 129.

A delay correction unit 118a is a delay correction unit for the RE 120 among the delay correction units 118 illustrated in FIG. 1. The delay correction unit 118a sends out the data to be wirelessly transmitted by the RE 120, to the RE 120 through the CPRI terminal unit 116 illustrated in FIG. 1 at a predetermined transmission timing. In this case, the delay correction unit 118a performs data advancing, which means sending out data at the timing earlier than the predetermined transmission timing by T12_1+Rx1.

A delay correction unit 147 and an antenna 149 illustrated in FIG. 2 are constituents of the RE 140 corresponding to the delay correction unit 127 and the antenna 129 of the RE 120. A delay time T12_2 is a delay time of the transmission between the REC 110 and the RE 140. A delay time Rx2 is a delay time (in-device delay time) of the transmission between the delay correction unit 147 of the RE 140 and the antenna 149.

A delay correction unit 118b is a delay correction unit for the RE 140 among the delay correction units 118 illustrated in FIG. 1. The delay correction unit 118b transmits to the RE 140 the data to be wirelessly transmitted by the RE 140 through the CPRI terminal unit 116 illustrated in FIG. 1 at a predetermined transmission timing. At this time, the delay correction unit 118b performs data advancing, which means sending out data at the timing earlier than the predetermined transmission timing by T12_2+Rx2.

The correction of the sending-out timing by the delay correction units 118a and 118b may be, for example, a correction by a chip-based period. One chip is, for example, a basic frame, which is described later. Thus, the timings for the REs 120, 140, and so on to wirelessly transmit data with may be corrected with an accuracy as fine as a chip.

The delay correction unit 127 of the RE 120 sends out the data transmitted from the REC 110, to the antenna 129. Here, the delay correction unit 127 corrects the timing of sending out the data to the antenna 129 by a period shorter than a chip (within a chip). This makes it possible to correct the timing of the RE 120 wirelessly transmitting the data with an accuracy finer than a chip.

The delay correction unit 147 of the RE 140 sends out the data transmitted from the REC 110, to the antenna 149. Here, the delay correction unit 147 corrects the timing of sending out the data to the antenna 149 by a period shorter than a chip (within a chip). This makes it possible to correct the timing of the RE 140 wirelessly transmitting the data with an accuracy finer than a chip.

As described above, in the base station system 100, the REC 110 is capable of adjusting the delay amount of the data for each of the REs 120, 140, and so on in accordance with the transmission delay amount (delay time) between the REC 110 and the antennas 129, 149, and so on. For example, it is possible for the REC 110 to correct roughly the data sending-out timings of the REs 120, 140, and so on, and for each RE to correct minutely the data sending-out timing. This reduces the delay correction amounts handled by the REs 120, 140, and so on, and makes it possible to reduce buffer amounts in the REs 120, 140, and so on, for example.

Here, the method of sharing the delay correction between the REC 110 and each RE is not limited to the example illustrated in FIG. 2. For example, without correcting the data sending-out timing at the REC 110, the data sending-out timing may be corrected by each RE.

(CPRI Frame Applicable to Embodiment)

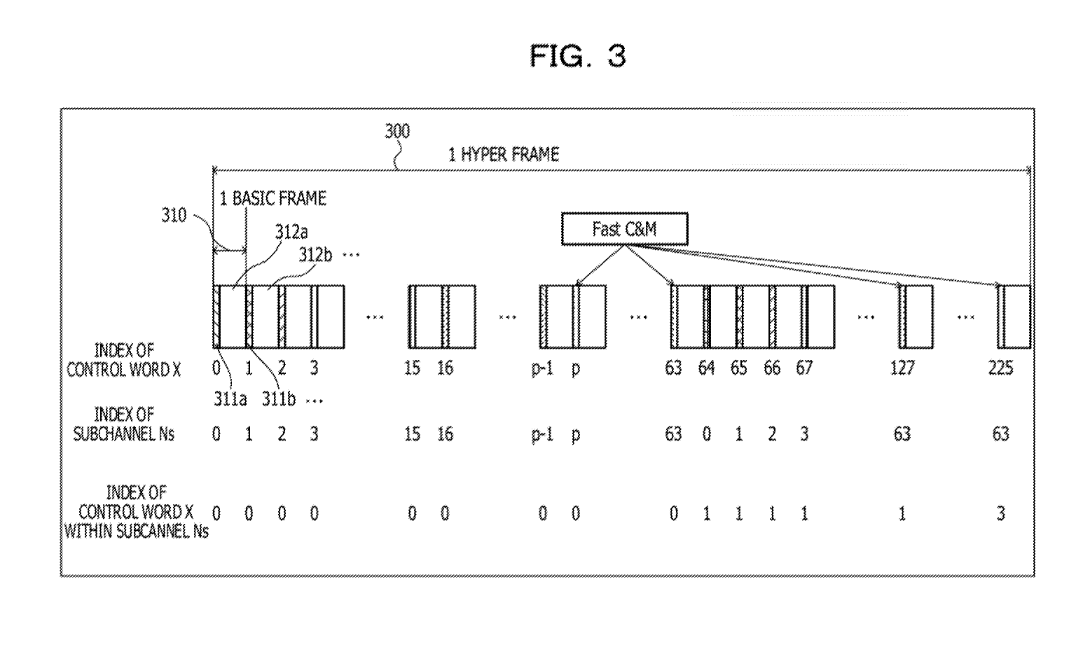

FIGS. 3 to 5 are diagrams Illustrating an example of a CPRI frame applicable to the embodiment. Although a description is provided here for the CPRI frame transmitted and received between the REC 110 and the RE 120, the CPRI frame transmitted and received, for example, between the RE 120 and the RE 140 is the same.

Between the REC 110 and the RE 120, a hyperframe 300 (1 hyperframe) illustrated in FIG. 3, for example, is transmitted and received as the CPRI frame. The hyperframe 300 includes 256 of basic frames 310 (1 basic frame indicates a basic frame 310). Control information pieces 311a, 311b, and so on are control information included in a first basic frame 310, a second basic frame 310, and so on included in the hyperframe 300. The control information pieces 311a, 311b, and so on are included in a front part of each basic frame 310. IQ data 312a, 312b, and so on are IQ data (payload) included in a first basic frame 310, a second basic frame 310, and so on in the hyperframe 300.

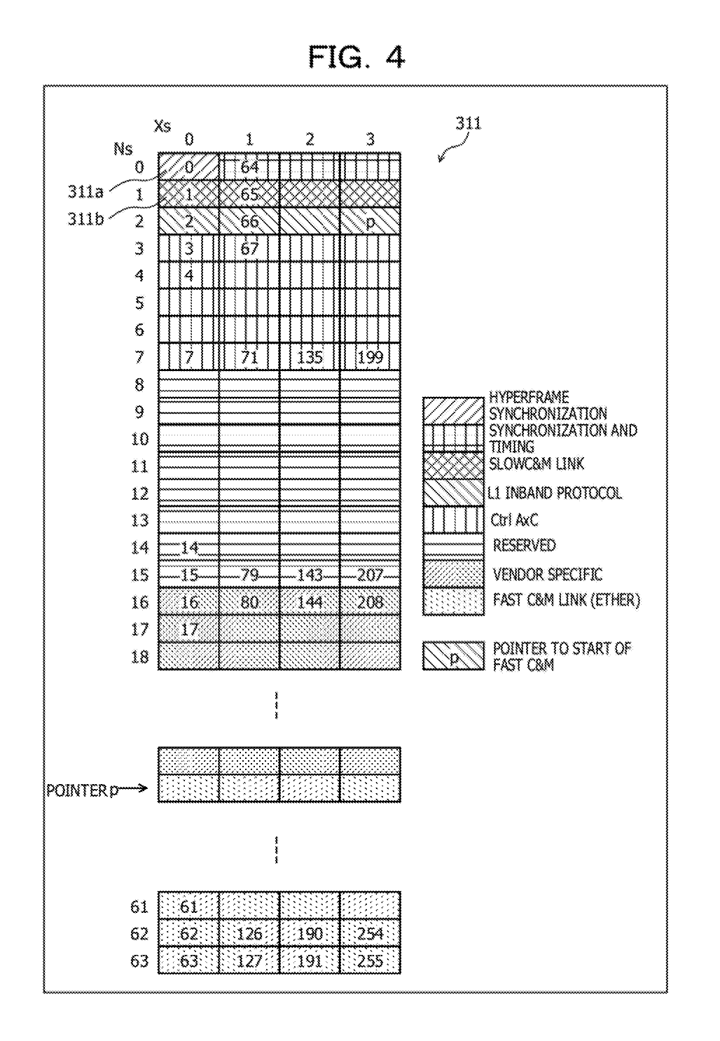

A control information group 311 illustrated in FIG. 4 is a diagram in which the control information pieces 311a, 311b, and so on included in the hyperframe 300 are laid out. As illustrated in the control information group 311, Hyperframe Synchronization, Fast C&M link (Ether), L1 inband protocol, and other information are mapped in the CPRI frame fixedly in a distributed manner. The PTP packet is mapped, for example, to Fast C&M link (Ether). The bandwidth of Fast C&M link (Ether) is narrower than that of the CPRI transmission path 103.

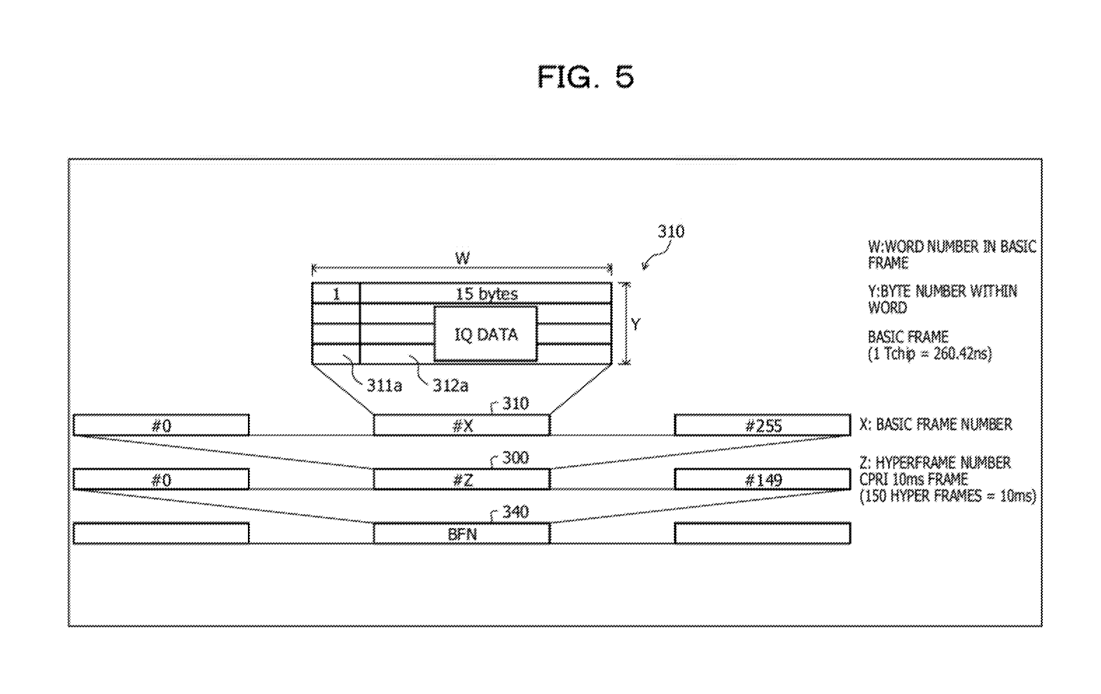

As illustrated in FIG. 5, the hyperframe 300 includes 256 of basic frames 310 (#0 to #X, and to #255). A BFN 340 (Node B Frame) includes 150 of hyperframes 300 (#0 to #Z, and to #149).

(Delay Correction Unit of RE According to Embodiment)

FIG. 6 is a diagram illustrating an example of the delay correction unit of an RE according to the embodiment. Although a description is provided for a delay correction unit 127 of the RE 120, the delay correction unit 147 of the RE 140 is also the same. As illustrated in FIG. 6, the delay correction unit 127 includes, for example, a write pointer circuit 601, a memory 602, a read pointer circuit 603, a time difference calculation unit 604, and a timing generation unit 605.

To the write pointer circuit 601, the IQ data (CPRI reception data) from the data distribution unit 126 (see FIG. 1, for example) is inputted as write data (DATA WRITE). The write pointer circuit 601 writes the inputted IQ data into the memory 602, designating a write pointer. The write pointer circuit 601 also notifies the timing generation unit 605 of the timing of writing the IQ data into the memory 602. The write timing of the IQ data is the timing when the write pointer circuit 601 writes the IQ data into the memory 602, for which the current time in the present device is used, for example.

The read pointer circuit 603 reads the IQ data from the memory 602, designating a read pointer by using a reference timing told by the timing generation unit 605 as a read timing. Then, the read pointer circuit 603 outputs the read IQ data (DATA READ) to the RF unit 128 (see FIG. 1, for example) as RF transmission data.

Based on the order of each pointer designated by the write pointer circuit 601 and the read pointer circuit 603, the memory 602 is used as a memory (buffer) for First In First Out (FIFO). This makes it possible to buffer the IQ data inputted to the delay correction unit 127.

The time difference calculation unit 604 calculates the time difference (phase gap) between the PTP timing outputted from the PTP synchronization timing generation unit 131 (see FIG. 1, for example) and the system timing outputted from the SYNC/CLK processing unit 124 (see FIG. 1, for example). This makes it possible to calculate the gap between the PTP timing to be synchronized with and the CPRI timing extracted from the CPRI transmission path 103.

Accordingly, by performing the delay correction of the IQ data based on the time difference calculated by the time difference calculation unit 604, even though the delay time in the CPRI transmission path 103 varies, it is possible to synchronize the wireless transmission timing of the IQ data with the PTP timing. The time difference calculation unit 604 notifies the timing generation unit 605 of the delay correction amount equal to the calculated time difference (phase gap).

The timing generation unit 605 generates the reference timing based on the delay correction amount told by the time difference calculation unit 604 and the write timing told by the write pointer circuit 601. The reference timing is a timing at which the read pointer circuit 603 reads the IQ data from the memory 602 and sends out the IQ data to the RF unit 128.

For example, the timing generation unit 605 generates the reference timing such that the difference between the write timing of the write pointer circuit 601 and the read timing of the read pointer circuit 603 becomes equal to the delay correction amount for each of the IQ data written in the memory 602. The timing generation unit 605 notifies the read pointer circuit 603 of the generated reference timing as the read timing.

As described above, the delay correction unit 127 of the RE 120 sequentially stores the IQ data received from the CPRI transmission path 103 in the memory 602 for FIFO, and reads the IQ data from the memory 602, operating the read pointer to be matched with the PTP timing. This makes it possible to wirelessly transmit the IQ data from the RE 120 at timings matched with the PTP timing.

When the delay correction unit 127 operates in accordance with the PTP timing based on the PTP time information at the time the PTP synchronization is established, even though the phase between the CPRI clock and the PTP time information fluctuates to some extent during the operation, if the fluctuations are within a specified range, the delay correction unit 127 may continue the operation, holding the initial phase. In this case, when the fluctuations of the phase between the CPRI clock and the PTP time information exceed the specified range, the delay correction unit 127 adjusts the correction timing again.

(Delay Correction Processing by RE According to Embodiment)

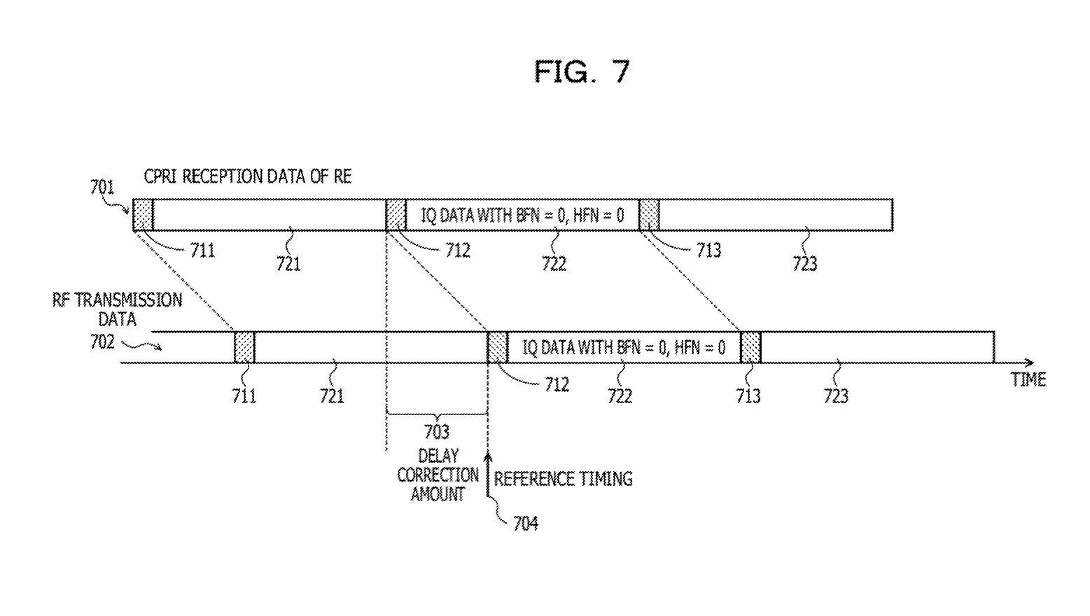

FIG. 7 is a diagram illustrating an example of delay correction processing by the RE according to the embodiment. Although a description is provided for the delay correction processing by the delay correction unit 127 of the RE 120, delay correction processing by the delay correction unit 147 of the RE 140 is the same. In FIG. 7, the horizontal axis represents the time. CPRI reception data 701 are the IQ data received from the REC 110 by the CPRI terminal unit 121 of the RE 120 and to be inputted to the delay correction unit 127.

The CPRI reception data 701 includes no-signal areas 711 to 713 and IQ data 721 to 723. The no-signal areas 711 to 713, which correspond to the sections where the control information pieces 311a, 311b, and so on included in the CPRI frame used to be stored illustrated in FIG. 3 for example, are time areas where no effective signal is present. The IQ data 721 to 723 correspond the IQ data 312a, 312b, and so on illustrated in FIG. 3, for example. For example, the IQ data 722 are the IQ data with a Node B frame number of 0 (BFN=0) and a hyperframe number of 0 (HFN=0).

RF transmission data 702 are the IQ data outputted from the delay correction unit 147 and wirelessly transmitted by the RF unit 128 and the antenna 129. A delay correction amount 703 is a delay correction amount calculated by the time difference calculation unit 604 of the delay correction unit 127 illustrated in FIG. 6. The timing generation unit 605 illustrated in FIG. 6, for example, generates a reference timing 704 such that the IQ data 722 is delayed by the delay correction amount 703. The read pointer circuit 603 illustrated in FIG. 6 reads the IQ data 722 at the reference timing 704. As described above, the delay correction unit 127 delays the inputted CPRI reception data 701 by the delay correction amount 703 and outputs the delayed CPRI reception data 701 as the RF transmission data 702.

(CPRI Terminal Unit According to Embodiment)

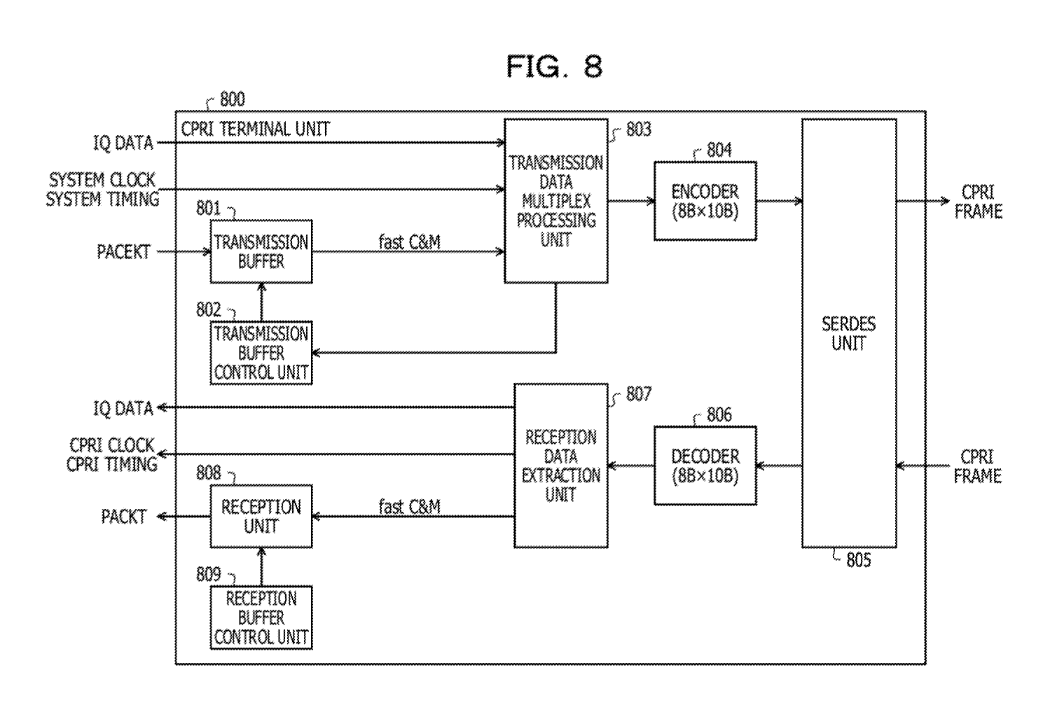

FIG. 8 is a diagram illustrating an example of the CPRI terminal unit according to the embodiment. Each of the CPRI terminal units 116, 121, and 130 illustrated in FIG. 1 may be implemented using, for example, a CPRI terminal unit 800 illustrated in FIG. 8. First, a description is given for a case where the CPRI terminal unit 116 is implemented using the CPRI terminal unit 800.

The CPRI terminal unit 800 includes a transmission buffer 801, a transmission buffer control unit 802, a transmission data multiplex processing unit 803, an encoder 804, and a SERDES unit 805. The CPRI terminal unit 800 also includes a decoder 806, a reception data extraction unit 807, a reception buffer 808, and a reception buffer control unit 809.

The transmission buffer 801 stores a packet (for example, an ether frame) outputted from the in-device switch 112 (see FIG. 1, for example). This packet includes the PTP packet. The packet stored in the transmission buffer 801 is read under the control of the transmission buffer control unit 802 and outputted to the transmission data multiplex processing unit 803.

The transmission buffer control unit 802 performs reading the packet from the transmission buffer 801 at a transmission timing told by the transmission data multiplex processing unit 803. This makes it possible to perform a speed conversion when converting the packet inputted to the transmission buffer 801 from the ether frame to the CPRI frame.

The transmission data multiplex processing unit 803 creates the CPRI frame by time-division multiplexing various information to be transmitted by the CPRI terminal unit 800 based on the system clock and the system timing from the SYNC/CLK processing unit 114 (see FIG. 1, for example). Then, the transmission data multiplex processing unit 803 outputs the created CPRI frame to the encoder 804. The information that the transmission data multiplex processing unit 803 time-division multiplexes includes, for example, the IQ data from the delay correction units 118 (see FIG. 1, for example), and a control word such as fast C&M included in the packet from the transmission buffer 801.

The transmission data multiplex processing unit 803 also notifies the transmission buffer control unit 802 of the transmission timing of the packet stored in the transmission buffer 801. The transmission timing of the packet is a timing at which the packet is able to be mapped in the transmission data multiplex processing unit 803.

The encoder 804 (8B×10B) encodes the CPRI frame outputted from the transmission data multiplex processing unit 803 from 8 bit codes to 10 bit codes in accordance with a predetermined correspondence table. This makes it possible to convert the CPRI frame outputted from the transmission data multiplex processing unit 803 such that the length of a period in which the same value (low or high) continues is shorter than or equal to four clocks. The encoder 804 outputs the encoded CPRI frame to the SERDES unit 805.

The SERDES unit 805 converts (serializes) the CPRI frame outputted from the encoder 804 from parallel data to serial data. Then, the SERDES unit 805 transmits the CPRI frame converted into the serial data to the RE 120 (see FIG. 1, for example) through the CPRI transmission path 103.

The SERDES unit 805 also converts (deserializes) the CPRI frame transmitted from the RE 120 (see FIG. 1, for example) from the serial data Into parallel data through the CPRI transmission path 103. Then, the SERDES unit 805 outputs the CPRI frame converted into the parallel data to the decoder 806.

The decoder 806 (8B×10B) decodes the CPRI frame outputted from the SERDES unit 805 from 10 bit codes to 8 bit codes in accordance with the predetermined correspondence table. Then, the decoder 806 outputs the decoded CPRI frame to the reception data extraction unit 807.

The reception data extraction unit 807 extracts the various information from the CPRI frame by time-demultiplexing the CPRI frame outputted from the decoder 806. For example, the reception data extraction unit 807 reproduces the clock (CPRI clock) of the CPRI frame by detecting a synchronization pattern included in the CPRI frame. The synchronization patter is, for example, the control information piece 311a (hyperframe synchronization) illustrated in FIG. 3.

The reception data extraction unit 807 also extracts the timing (CPRI timing) of the CPRI frame using the reproduced CPRI clock. Then, the reception data extraction unit 807 time-demultiplexes the CPRI frame based on the obtained CPRI clock and CPRI timing. The information that the reception data extraction unit 807 extracts by the time-multiplexing includes, for example, the IQ data and a packet of fast C&M and the like.

The reception data extraction unit 807 outputs the obtained CPRI clock and CPRI timing to the SYNC/CLK processing unit 124 (see FIG. 1, for example). The reception data extraction unit 807 also outputs the extracted packet (ether frame) of fast C&M and the like to the reception buffer 808. In addition, the reception data extraction unit 807 outputs the extracted IQ data to the baseband processing unit 115 (see FIG. 1, for example).

The reception buffer 808 stores the packet (for example, the ether frame) outputted from the reception data extraction unit 807. The packet stored in the reception buffer 808 is read under the control of the reception buffer control unit 809 and outputted to the in-device switch 112 (see FIG. 1, for example).

The reception buffer control unit 809 performs reading the packet from the reception buffer 808. For example, when all the data in a packet are stored in the reception buffer 808, the reception buffer control unit 809 performs reading the packet from the reception buffer 808. This makes it possible to perform a speed conversion when converting the packet inputted to the reception buffer 808 from the CPRI frame to the ether frame.

(PTP Processing According to Embodiment)

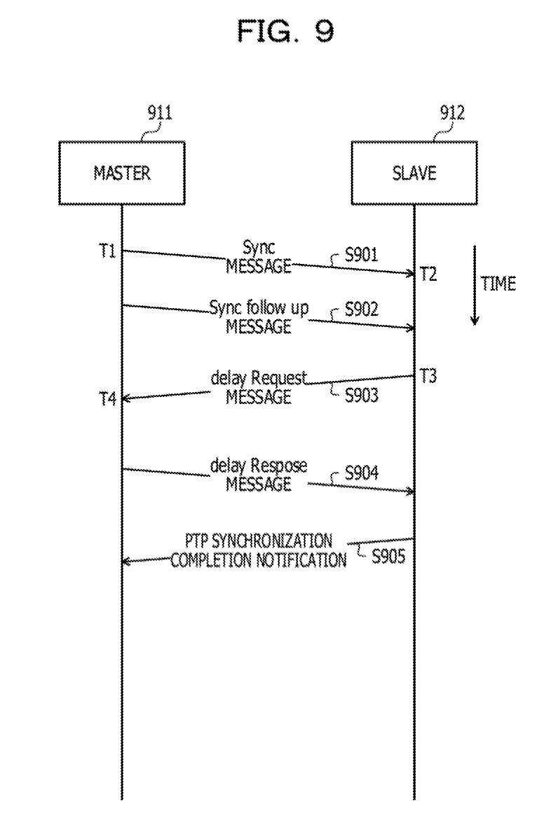

FIG. 9 is a sequence diagram illustrating an example of PTP processing according to the embodiment. In the embodiment, the PTP processing illustrated in FIG. 9 is performed. A master 911 illustrated in FIG. 9 is the master of the PTP processing. A slave 912 illustrated in FIG. 9 is a slave of the PTP processing and is to be time-synchronized with the master 911.

As an example, in the case where the REC 110 is to be time-synchronized with the PTP master 101 using PTP, the PTP master 101, servings as the master 911, and the REC 110, serving as the slave 912, execute each step illustrated in FIG. 9. In the case where the RE 120 is to be time-synchronized with the REC 110 using PTP, the REC 110, servings as the master 911, and the RE 120, serving as the slave 912, execute each step illustrated in FIG. 9.

First, the master 911 transmits a Sync message to the slave 912 (step S901). Time T1 is the time according to the master 911 measured when the master 911 transmits the Sync message at step S901. Time T2 is the time according to the slave 912 measured when the slave 912 receives the Sync message at step S901. Next, the master 911 transmits a Sync follow up message indicating the time T1 to the slave 912 (step S902).

Then, the slave 912 transmits a delay Request message to the master 911 (step S903). Time T3 is the time according to the slave 912 measured when the slave 912 transmits the delay Request message at step S903. Time T4 is the time according to the master 911 measured when the master 911 receives the delay Request message at step S903.

Next, the master 911 transmits a delay Response message indicating the time T4 to the slave 912 (step S904). The slave 912 is able to create the PTP time information synchronized with the current time according to the master 911 based on the times T1 to T4. Then, the slave 912 transmits to the master 911 a PTP synchronization completion notification indicating that the PTP synchronization is completed (step S905), and terminates the series of processes.

At step S904, the slave 912 is able to calculate an offset amount (offsetFromMaster) for the current time according to the slave 912 relative to the current time according to the master 911, using: offsetFromMaster={(T2−T1)−(T4−T3)}/2, for example. In other words, the relation between the time T1 measured when the master 911 transmits the PTP packet and the time T2 measured when the slave 912 receives the PTP packet is expressed as: T1=T2+offsetFromMaster−[transmission delay time of the PTP packet]. Note that the transmission delay time of the PTP packet is expressed, using an average (meanPathDelay) of the transmission delay time of the Sync message and the delay Request message, as: the average transmission delay time (meanPathDelay)={(T2−T1)+(T4−T3)}/2. Then, the slave 912 generates the PTP time information synchronized with the current time according to the master 911 by correcting the current time according to the slave 912 based on the calculated offset amount. Note that in the case where delay information (correctionField value) is set in the PTP packets (Sync message, Delay_Resp message), the offset amount and the average transmission delay time may be calculated in consideration of the delay information.

As described above, the slave 912 transmits and receives the PTP messages to and from the master 911, such as the Sync message, the Sync follow up message, the delay Request message, and the delay Response message. Then, the slave 912 controls the current time according to the slave 912 to be synchronized with the current time according to the master 911 based on the time information (T1 to T4) acquired through the transmission and reception of the PTP messages.

Here, PTP processing performed in the base station system 100 is not limited to the PTP processing illustrated in FIG. 9, and various kinds of time synchronization processing may be used. For example, the master 911 may store a predicted value of the time T1 in the Sync message to be transmitted at step S901. Then, the master 911 stores information indicating the actual time T1 in the Sync follow up message to be transmitted at step S902. This makes it possible for the slave 912 to compensate the predicted value of the time T1 obtained by the Sync message based on the information stored in the Sync follow up message.

Alternatively, the master 911 may store the predicted value of the time T1 in the Sync message to be transmitted at step S901 and skip step S902. In this case, the slave 912 is able to generate PTP time information synchronized with the current time according to the master 911, using the predicted value of the time T1 obtained from the Sync message.

(Impartation of Delay Information by In-Device Switch According to Embodiment)

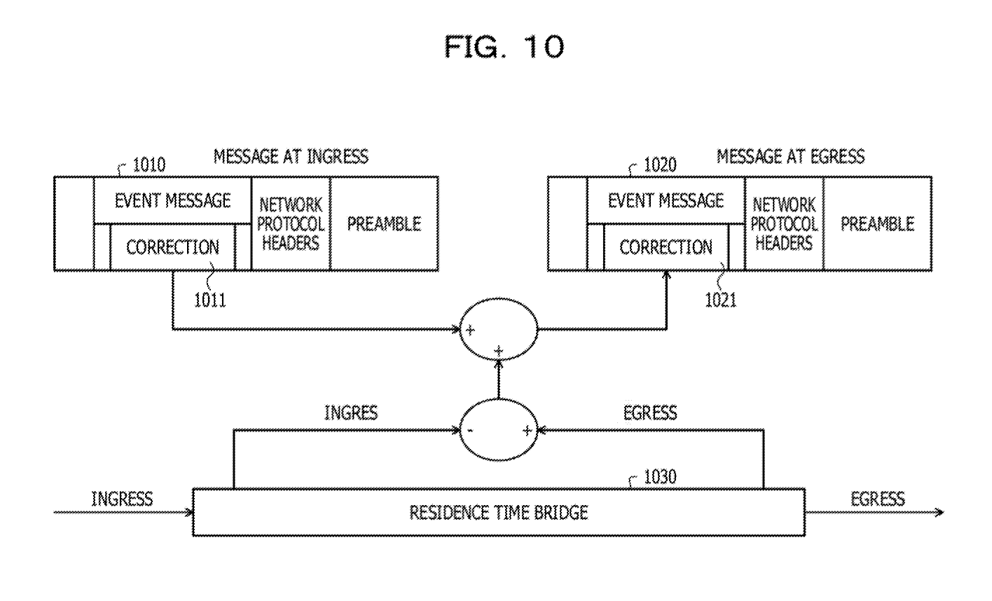

FIG. 10 is a diagram illustrating an example of impartation of delay information by the in-device switch according to the embodiment. In the case where the PTP processing with the transparent clock is performed between the REC 110 and REs 120, 140, and so on, the in-device switch 112 of the REC 110 imparts delay information illustrated in FIG. 10, for example.

A PTP packet 1010 illustrated in FIG. 10 is a PTP packet (Message at ingress) at an input part (ingress) of the in-device switch 112. A PTP packet 1020 is a PTP packet (Message at egress) at an output part (egress) of the in-device switch 112.

The in-device switch 112 transfers the PTP packet 1010 received from the PTP master 101 to the PTP terminal unit 113 through NW terminal unit 111 as the PTP packet 1020. A residence time bridge 1030 indicates internal processing (waiting) of the in-device switch 112.

The in-device switch 112 subtracts an ingress time (reception time) of the PTP packet 1010 and adds an egress time (transmission time) of the PTP packet 1020 from and to a value in a Correction field 1011 of the PTP packet 1010. Then, the in-device switch 112 uses the result of the addition and subtraction as a value of a Correction field 1021 of the PTP packet 1020.

This makes it possible to notify subsequent stages of the waiting time (delay time) at the residence time bridge 1030 of the in-device switch 112, using the Correction field 1021 included in the PTP packet 1020. By doing this, the sum total of delay time of each switch (for example, the in-device switch 112) is communicated using the Correction field of the PTP packet. This makes it possible for the PTP slave to know an accurate delay time from the PTP master using the Correction field.

As described above, by communicating the waiting time at the in-device switch 112, which is a major factor of a delay error, for example, for the PTP packet, using the Correction field, it is possible to calculate an accurate delay time on the PTP slave side.

(SYNC/CLK Processing Unit According to Embodiment)

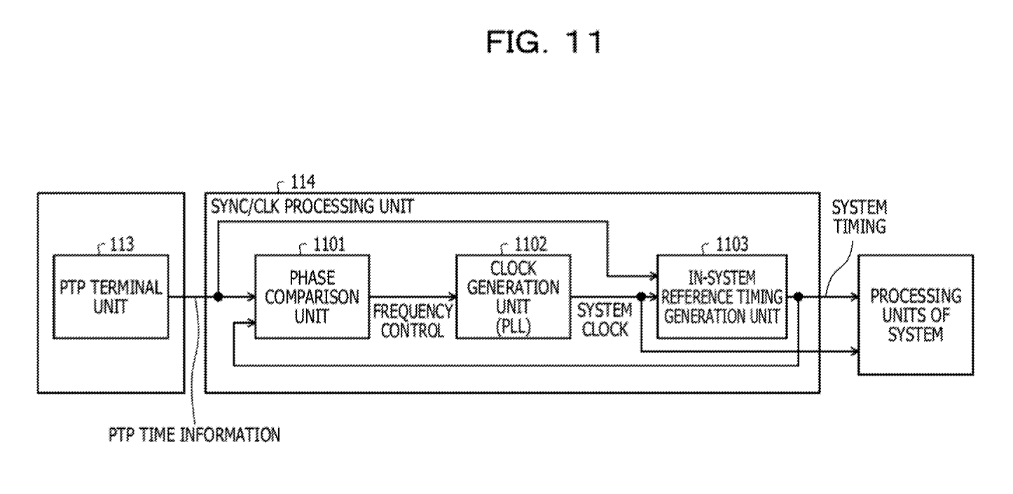

FIG. 11 is a diagram illustrating an example of the SYNC/CLK processing unit according to the embodiment. As described above, the REC 110 serves as a PTP slave to be time-synchronized with the PTP master 101. To this end, the SYNC/CLK processing unit 114 of the REC 110 includes a phase comparison unit 1101, a clock generation unit 1102, and an in-system reference timing generation unit 1103 as illustrated in FIG. 11, for example.

The phase comparison unit 1101 compares the PTP time Information from the PTP terminal unit 113 and the system timing from the in-system reference timing generation unit 1103. This makes it possible to detect a gap between the clock and timing indicated by the PTP time information from the PTP terminal unit 113 and the system clock and system timing according to the present device.

The phase comparison unit 1101 controls (frequency controls) the frequency of the system clock generated by the clock generation unit 1102 by outputting the comparison result to the clock generation unit 1102. Repeating this makes it possible to bring a system clock and system timing of the present device into agreement with the system clock and system timing indicated by the PTP time information from the PTP terminal unit 113.

The clock generation unit 1102 generates the system clock serving as a reference clock inside the present device. For example, the clock generation unit 1102 may be implemented using PLL (phase locked loop: phase synchronization circuit). The frequency of the system clock generated by the clock generation unit 1102 is controlled by the output of the phase comparison unit 1101. The system clock generated by the clock generation unit 1102 is outputted to the in-system reference timing generation unit 1103 and the processing units (processing units of the system) inside the present device.

The in-system reference timing generation unit 1103 generates the system timing based on the system clock from the clock generation unit 1102 and the PTP time information from the PTP terminal unit 113. The system timing is, for example, a frame number the value of which is incremented at each cycle of the system clock. The system timing generated by the in-system reference timing generation unit 1103 is outputted to the processing units (processing units of the system) inside the present device.

When the gap detected by the phase comparison unit 1101 is within a specified range, the SYNC/CLK processing unit 114 may determine that the present device has come into synchronization with the master. In this case, the SYNC/CLK processing unit 114 may suspend the adjustment of the system clock and system timing to output until the gap detected by the phase comparison unit 1101 is out of the specified range.

(PTP Slave Operation in RE According to Embodiment)

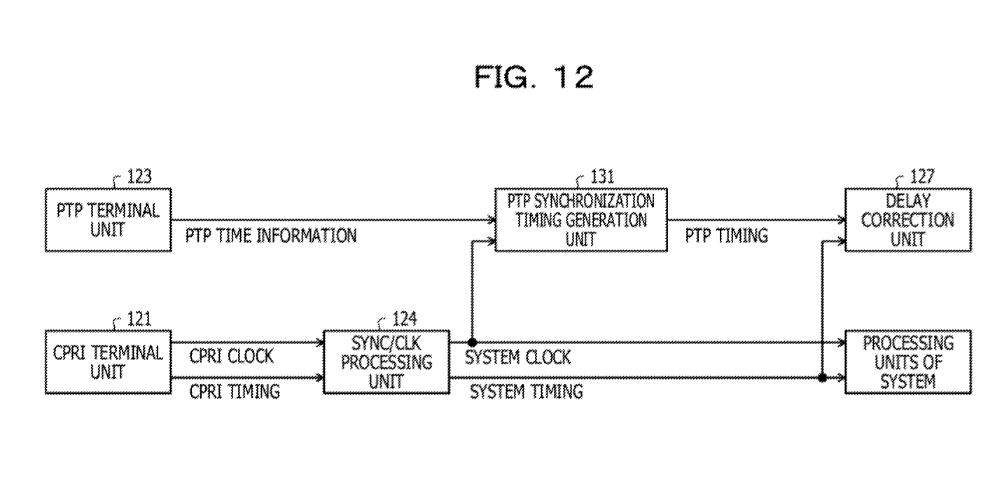

FIG. 12 is a diagram illustrating an example of PTP slave operation in the RE according to the embodiment. In FIG. 12, the same units as those in FIG. 1 are denoted by the same reference signs, and descriptions thereof are omitted. Although a description is provided for the PTP slave operation of the RE120, PTP slave operation of the RE 140 is also the same. As Illustrated in FIG. 12, the CPRI terminal unit 121 outputs the CPRI clock and CPRI timing obtained from the CPRI transmission path 103 to the SYNC/CLK processing unit 124.

The SYNC/CLK processing unit 124 generates a system clock and system timing according to the present device in such a way as to be synchronized with the CPRI clock and the CPRI timing outputted from the CPRI terminal unit 121. Then, the SYNC/CLK processing unit 124 outputs the generated system clock and system timing to the processing units in the present device. The SYNC/CLK processing unit 124 also outputs the generated system clock to the PTP synchronization timing generation unit 131. The SYNC/CLK processing unit 124 also outputs the generated system timing to the delay correction unit 127.

The PTP synchronization timing generation unit 131 generates the PTP timing that is based on the PTP time information outputted from the PTP terminal unit 123 and the system clock outputted from the SYNC/CLK processing unit 124. For example, the PTP synchronization timing generation unit 131 generates a PTP timing that indicates the frame number incremented at each cycle of the system clock from the SYNC/CLK processing unit 124, and the frame number of which is synchronized with the PTP time information. Then, the PTP synchronization timing generation unit 131 outputs the generated PTP timing to the delay correction unit 127.

The delay correction unit 127 performs delay correction of the IQ data to be wirelessly transmitted based on the PTP timing outputted from the PTP synchronization timing generation unit 131 and the system timing outputted from the SYNC/CLK processing unit 124.

As described above, the RE 120 generates the PTP timing based on timing indicated by the PTP time information based on the transmission and reception of the PTP packet, and the system clock obtained from the CPRI frame. This makes it possible to generate the PTP timing synchronized with the PTP time information in a stable manner by using the system clock obtained from the CPRI frame, without transmitting and receiving the PTP packet all the time between the REC 110 and the RE 120.

Here, while the CPRI is synchronized, it is possible to determine that the reference clock is synchronized with the host device. In this case, transmission and reception of the PTP packet do not have to be repeated. For this reason, only one transmission and reception of the PTP packet makes it possible to synchronize the PTP time with the reference timing of the system.

(Variation in In-Device Delay Time in CPRI Terminal Unit According to Embodiment)

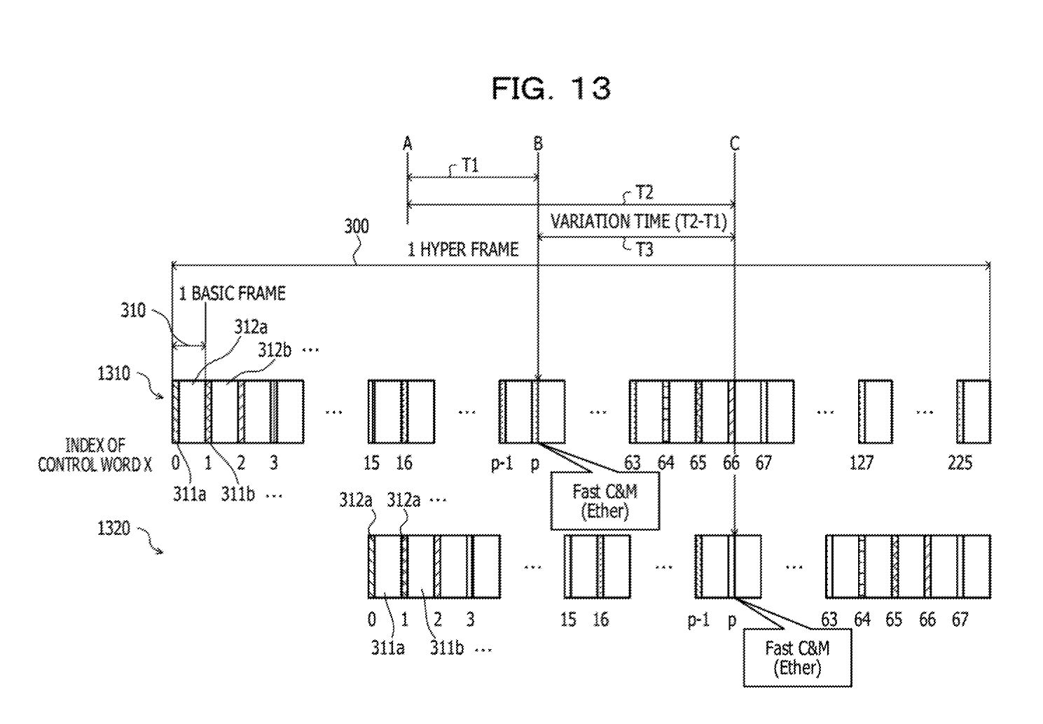

FIG. 13 is a diagram illustrating an example of variation in in-device delay time in the CPRI terminal unit according to the embodiment. In FIG. 13, the same units as those in FIG. 3 are denoted by the same reference signs, and descriptions thereof are omitted. Although a description is provided here for the variation in the delay time in the transmission part of the CPRI terminal unit 116 of the REC 110, variation in the delay time in the transmission part of the CPRI terminal unit 130 of the RE120 is the same.

Time A represents the time of a timing when a packet to be transmitted is inputted to the CPRI terminal unit 116, in other words, a packet reception timing at the CPRI terminal unit 116. In the example illustrated in FIG. 13, the CPRI terminal unit 116 maps the packet received at the time A to the fast C&M link (ether) of the hyperframe 300 (CPRI frame).

A timing example 1310 is a first example of the timing of the hyperframe 300 relative to the time A. Time B represents the time of a timing of the fast C&M (ether) of the hyperframe 300 in the timing example 1310. In the timing example 1310, the CPRI terminal unit 116 makes the packet received at the time A wait until the time B, and then maps the packet to the fast C&M (ether). In this case, the delay amount of the packet in the CPRI terminal unit 116 is a delay time T1 between the time A and the time B.

A timing example 1320 is a second example of the timing of the hyperframe 300 relative to the time A. Time C represents the time of a timing of the fast C&M (ether) of the hyperframe 300 in the timing example 1320. In the timing example 1320, the CPRI terminal unit 116 makes the packet received at the time A wait until the time C, and then maps the packet to the fast C&M (ether). In this case, the delay amount of the packet in the CPRI terminal unit 116 is a delay time T2 between the time A and the time C.

Accordingly, in the example illustrated in FIG. 13, according to the comparison of the timing example 1310 and 1320, variation in the packet delay amount of T3 (=T2−T1) occurs in the CPRI terminal unit 116. As described above, since the bandwidth to which a packet may be mapped is limited in an Ethernet link with CPRI, variation in the delay amount for packets occurs because of the relation between a timing when a packet is inputted and a timing when the packet may be mapped.

For this reason, when the PTP packet is transmitted or received using the CPRI transmission path 103, for example, variation in the delay time occurs at the CPRI terminal unit 116 for the PTP packet outputted from the in-device switch 112 to the CPRI terminal unit 116. The variation in the delay time at the CPRI terminal unit 116 decreases accuracy of the time synchronization by the PTP packet.

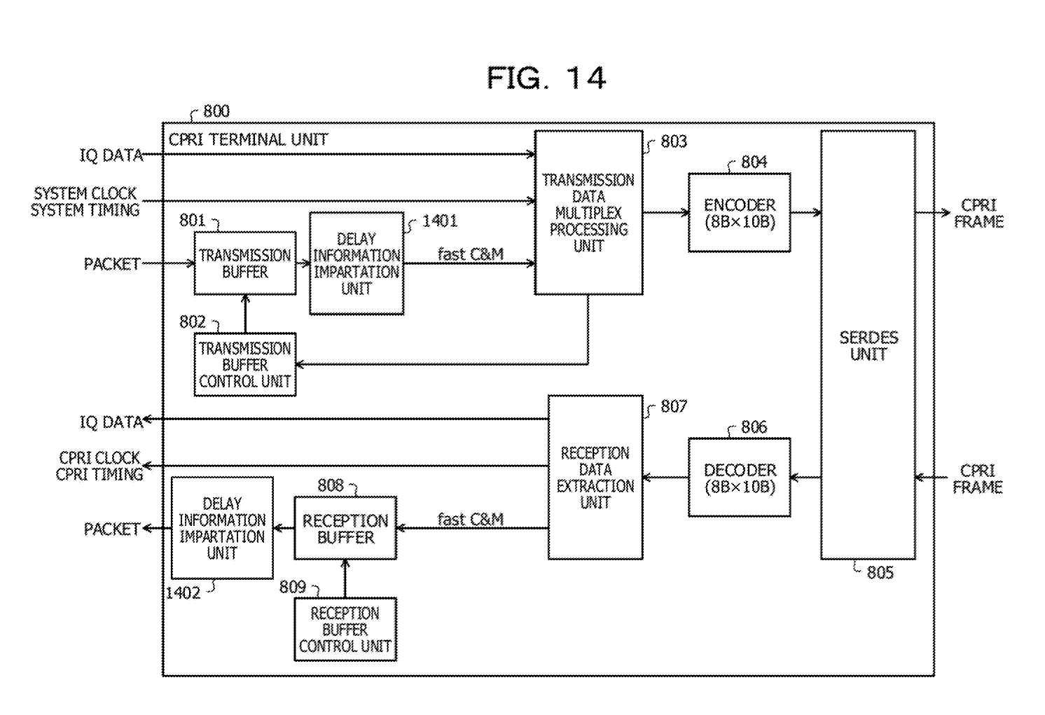

To address this, it is possible for the base station system 100 to reduce degradation in the accuracy in the time synchronization by the PTP packet by providing a function of imparting delay information to the PTP packet for the CPRI terminal unit 116. With reference to FIG. 14, a description is provided for the function of imparting the delay information to the PTP packet.

(Another Example of CPRI Terminal Unit According to Embodiment)

FIG. 14 is a diagram Illustrating another example of the CPRI terminal unit according to the embodiment. In FIG. 14, the same units as those in FIG. 8 are denoted by the same reference signs, and description thereof are omitted. In the case where the PTP processing with the transparent clock is performed between the REC 110 and REs 120, 140, and so on, the CPRI terminal unit 800 may include a delay information impartation units 1401 and 1402 as illustrated in FIG. 14 in addition to the configuration illustrated in FIG. 8.

When a packet read from the transmission buffer 801 and to be outputted to the transmission data multiplex processing unit 803 is a PTP packet, the delay information impartation unit 1401 imparts delay information to the PTP packet. The delay information is information indicating delay time of the PTP packet in the CPRI terminal unit 800. This delay time is a delay time caused by waiting to map a PTP packet to the fast C&M (ether), for example.

When a packet read from the reception buffer 808 and to be outputted from the CPRI terminal unit 800 is a PTP packet, the delay information impartation unit 1402 imparts delay information to the PTP packet. The delay information is information indicating delay time of the PTP packet in the CPRI terminal unit 800. This delay time is a delay time caused by waiting all the data of the packet in the reception buffer 808, which is caused by a lower transmission rate of the CPRI transmission path 103 than the transmission rate inside the RE 120, for example.

For example, in the case where the CPRI terminal unit 800 illustrated in FIG. 14 is applied to the CPRI terminal unit 116, it is possible to impart delay information indicating the delay time in the CPRI terminal unit 116 to a PTP packet to be transmitted from the REC 110 to the RE 120 through the CPRI transmission path 103. In addition, it is possible to impart delay information indicating the delay time in the CPRI terminal unit 121 to a PTP packet received by the RE 120 through the CPRI transmission path 103.

In this case, the PTP terminal unit 123 of the RE 120 corrects the PTP time information based on PTP packets transmitted and received to and from the REC 110 based on the delay information received from the REC 110. For example, the PTP terminal unit 123 generates information indicating an earlier time than the time indicated by the PTP time information by the delay time Indicated by the delay information, as PTP time information after correction. Then, the PTP terminal unit 123 outputs the generated PTP time Information after correction to the PTP synchronization timing generation unit 131. This makes it possible to obtain PTP time information with high accuracy at the RE 120 even though there is a delay time in the CPRI terminal unit 116.

The impartation of delay Information by the delay information impartation units 1401 and 1402 may be performed by using a Correction field of the PTP packet, for example, in the same way as the impartation of delay information by the in-device switch 112 illustrated in FIG. 10.

(Transmission Processing by CPRI Terminal Unit According to Embodiment)

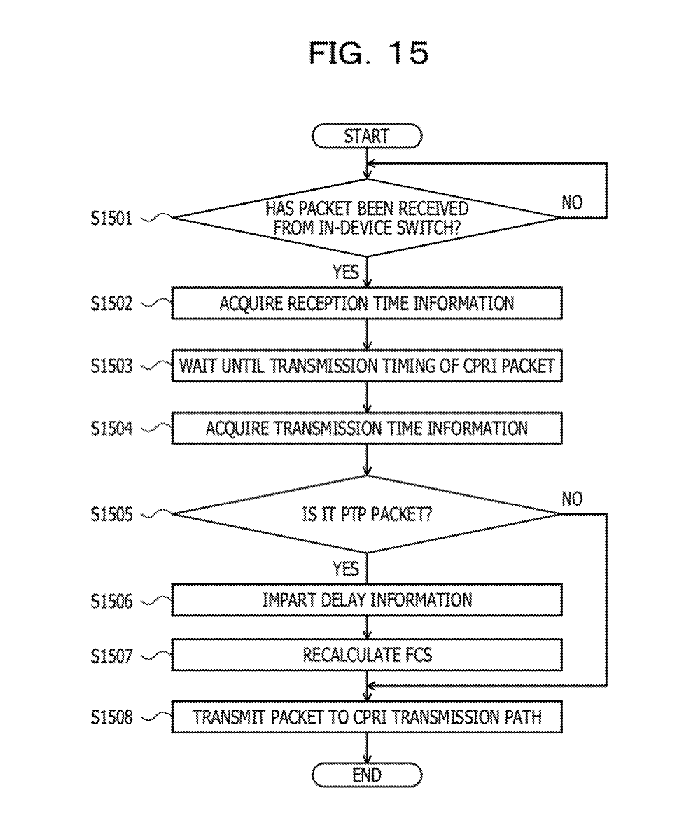

FIG. 15 is a flowchart Illustrating an example of transmission processing by the CPRI terminal unit according to the embodiment. The CPRI terminal unit 800 illustrated in FIG. 14 executes, for example, each step Illustrated in FIG. 15 as transmission processing to transmit a packet outputted from an in-device switch (for example, the in-device switch 112). Although a description is provided here for the case where the CPRI terminal unit 800 is applied to the CPRI terminal unit 116 of the REC 110, the case where the CPRI terminal unit 800 is applied to the CPRI terminal unit 130 of the RE 120 is the same.

First, the CPRI terminal unit 800, judging whether or not a packet has been received from the in-device switch 112 (step S1501), waits until a packet is received from the in-device switch 112 (No loop at step S1501). When receiving a packet from the in-device switch 112 (Yes at step S1501), the CPRI terminal unit 800 acquires reception time information indicating the time of receiving the packet at step S1501 (step S1502). It is possible to acquire the reception time information, for example, from time information (system timing) outputted from the SYNC/CLK processing unit 114 at the time of step S1502.

Next, the CPRI terminal unit 800 waits until the transmission timing of the CPRI packet (step S1503). The transmission timing of the CPRI packet is a timing when the packet received at step S1501 may be transmitted, for example, the time B in the timing example 1310 or the time C in the timing example 1320 illustrated in FIG. 13.

Next, the CPRI terminal unit 800 acquires transmission time information indicating the time when the packet received at step S1501 is to be transmitted (step S1504). It is possible to acquire the transmission time information, for example, from time information (system timing) outputted from the SYNC/CLK processing unit 114 at the time of step S1504.

Next, the CPRI terminal unit 800 judges whether or not the packet received at step S1501 is a PTP packet (step S1505). When the received packet is not a PTP packet (No at step S1505), the CPRI terminal unit 800 proceeds to step S1508.

When the received packet is a PTP packet at step S1505 (Yes at step S1505), the CPRI terminal unit 800 imparts delay information to the received PTP packet (step S1506). The delay information is information indicating a difference between the time indicated by the reception time information acquired at step S1502 and the time indicated by the transmission time information acquired at step S1504.

The CPRI terminal unit 800 also recalculates the frame check sequence (FCS) of the PTP packet to which the delay information is imparted at step S1506 (step S1507). Then, the CPRI terminal unit 800 imparts the FCS recalculated at step S1507 to the PTP packet.

Next, the CPRI terminal unit 800 transmits the packet received at step S1501 to the CPRI transmission path 103 (step S1508) and terminates the series of processes. In the case where steps S1506 and S1507 have been executed, the packet to be transmitted at step S1508 is a packet to which the delay information and the recalculated FCS are imparted.

Note that steps S1502 and S1504 may be processes to be executed only if the received packet is a PTP packet.

(Reception Processing by CPRI Terminal Unit According to Embodiment)

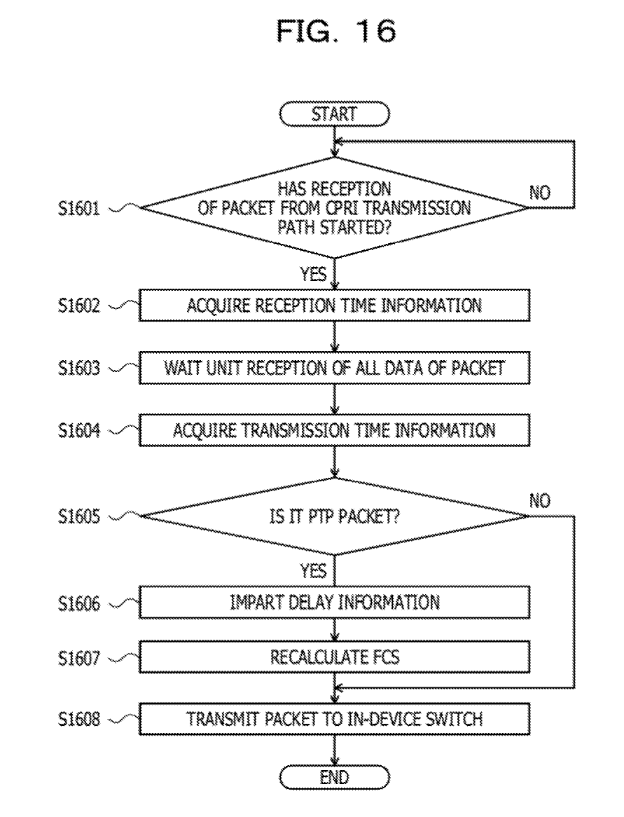

FIG. 16 is a flowchart Illustrating an example of reception processing by the CPRI terminal unit according to the embodiment. The CPRI terminal unit 800 illustrated in FIG. 14 executes, for example, each step illustrated in FIG. 16 as reception processing to receive a packet transmitted from a CPRI transmission path (for example, the CPRI transmission path 103). Although a description is provided here for the case where the CPRI terminal unit 800 is applied to the CPRI terminal unit 116 of the REC 110, the case where the CPRI terminal unit 800 is applied to the CPRI terminal unit 130 of the RE 120 is also the same.

First, the CPRI terminal unit 800, judging whether or not reception of a packet from the CPRI transmission path 103 has started (step S1601), waits until the reception of a packet from the CPRI transmission path 103 starts (No loop at step S1601). The judgment at step S1601 may be performed, for example, by judging whether or not a front part of a packet has been detected from a signal received from the CPRI transmission path 103.

On starting to receive a packet from the CPRI transmission path 103 at step S1601 (Yes at step S1601), the CPRI terminal unit 800 acquires reception time information indicating the time of starting to receive the packet (step S1602). It is possible to acquire the reception time information, for example, from time information (system timing) outputted from the SYNC/CLK processing unit 114 at the time of step S1602.

Next, the CPRI terminal unit 800 waits until reception of all the data (for example, for one packet) of the packet started to be received at step S1601 (step S1603). Next, the CPRI terminal unit 800 acquires transmission time information indicating the time the packet received at step S1601 is to be transmitted (step S1604). It is possible to acquire the transmission time information, for example, from the time information (system timing) outputted from the SYNC/CLK processing unit 114 at the time of step S1604.

Next, the CPRI terminal unit 800 judges whether or not the packet received at step S1601 is a PTP packet (step S1605). When the received packet is not a PTP packet (No at step S1605), the CPRI terminal unit 800 proceeds to step S1608.

When the received packet is a PTP packet at step S1605 (Yes at step S1605), the CPRI terminal unit 800 imparts delay information to the received PTP packet (step S1606). The delay information is information indicating a difference between the time indicated by the reception time information acquired at step S1602 and the time indicated by the transmission time information acquired at step S1604.

The CPRI terminal unit 800 also recalculates the FCS of the PTP packet to which the delay information is imparted at step S1606 (step S1607). Then, the CPRI terminal unit 800 imparts the FCS recalculated at step S1607 to the PTP packet.

Next, the CPRI terminal unit 800 transmits the packet received at step S1601 (step S1608) to the in-device switch 112 and terminates the series of processes. In the case where steps S1606 and S1607 have been executed, the packet to be transmitted at step S1608 is a packet to which the delay information and the recalculated FCS are imparted.

Note that steps S1602 and S1604 may be processes to be executed only if the received packet is a PTP packet.

(Notification of Transmission Timing According to Embodiment)

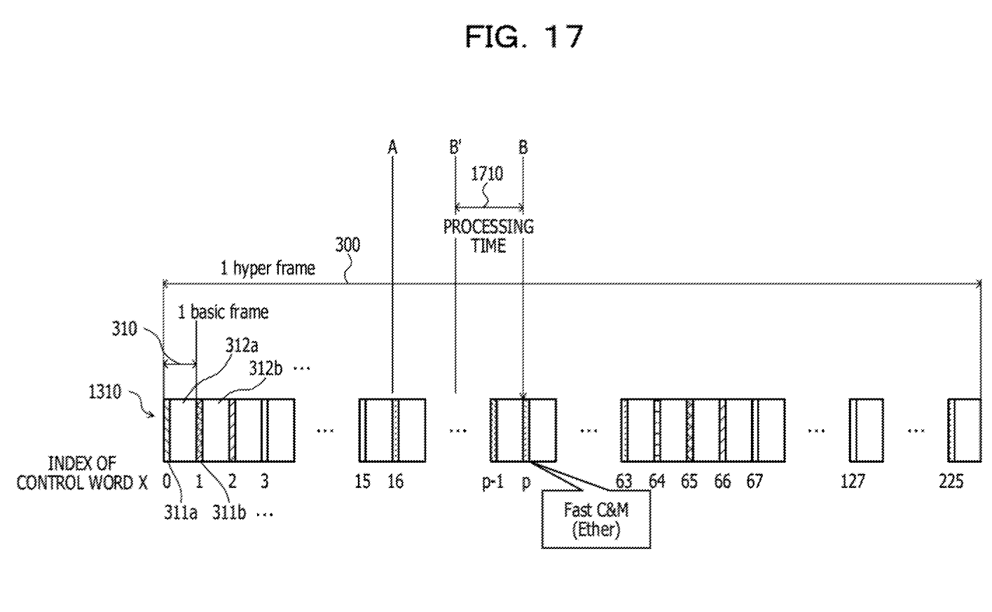

FIG. 17 is a diagram illustrating an example of notification of a transmission timing according to the embodiment. In FIG. 17, the same units as those in FIG. 13 are denoted by the same reference signs, and descriptions thereof are omitted. In the CPRI terminal unit 800 illustrated in FIG. 14, it may take a time for the delay information impartation unit 1401 to perform processing of imparting delay information to a PTP packet. In this case, the transmission data multiplex processing unit 803 may notify the transmission buffer control unit 802 of the transmission timing of the PTP packet stored in the transmission buffer 801, at an earlier timing.

For example, as illustrated in FIG. 17, the transmission data multiplex processing unit 803 notifies the transmission buffer control unit 802 of a transmission timing indicating the time B, at time B′ which is earlier than the time B at which the PTP packet may be transmitted, by a time 1710 corresponding to a time taken to impart the delay information. Responding to this operation, the transmission buffer control unit 802 performs control to read the packet stored in the transmission buffer 801 at the earlier timing (time B′) than the time B by the time 1710. Accordingly, even though it takes a time to impart the delay information to the PTP packet, this makes it possible to transmit the PTP packet at the transmission timing.

(PTP Processing with Boundary Cock Performed by RE According to Embodiment)

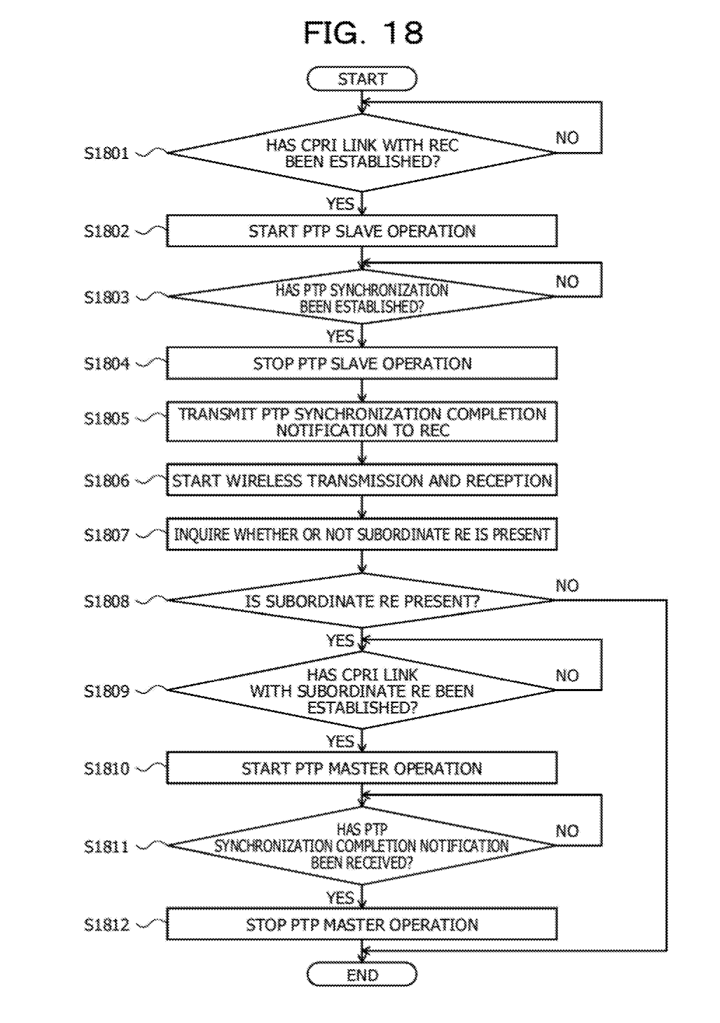

FIG. 18 is a flowchart illustrating an example of the PTP processing with the boundary clock performed by RE according to the embodiment. In the case where the PTP processing with the boundary clock is performed with the REs 120, 140, and so on coupled to the REC 110 in a cascading manner, each of the REs 120, 140, and so on executes, for example, each step illustrated in FIG. 18 as the PTP processing. Here, a description is provided for the PTP processing performed by the RE 120.

First, the RE 120, judging whether or not a CPRI link (REC inf) with the REC 110 has been established (step S1801), waits until the CPRI link with the REC 110 is established (No loop at step S1801). During the period, the RE 120 performs processing to establish the CPRI link with the REC 110. At step S1801, for example, when the PTP timing described above is obtained, the RE 120 judges that the synchronization is established.

At step S1801, when the CPRI link with the REC 110 is established (Yes at step S1801), the RE 120 starts PTP slave operation (step S1802). Thus, the PTP processing (for example, see FIG. 9) is performed with the REC 110 serving as the PTP master, and the RE120 serving as the PTP slave.

Next, the RE 120, judging whether or not the PTP synchronization (time synchronization) with the REC 110 has been established (step S1803), waits until the PTP synchronization with the REC 110 is established (No loop at step S1803). When the PTP synchronization with the REC 110 is established (Yes at step S1803), the RE 120 stops the PTP slave operation (step S1804). The RE 120 also outputs a PTP synchronization completion notification to the REC 110 (step S1805).

Next, the RE 120 starts wireless transmission and reception (step S1806). At step S1806, the RE 120 performs the delay correction to the IQ data that the RE 120 wirelessly transmits based on the PTP time synchronized at step S1803.

Next, the RE 120 inquires of the REC 110 whether or not a subordinate RE (for example RE 140) is present under the RE120 (step S1807). Then, the RE 120 judges whether or not a subordinate RE is present under the RE 120, based on the response from the REC 110 to the inquiry made at step S1807 (step S1808).

When judging that no subordinate RE is present at step S1808 (No at step S1808), the RE 120 terminates the series of processes. If it is judged that a subordinate RE is present (Yes at step S1808), the RE 120 proceeds to step S1809. That is the RE 120, judging whether or not a CPRI link with the subordinate RE has been established (step S1809), waits until the CPRI link with the subordinate RE is established (No loop at S1809). During the period, the RE 120 performs processing to establish the CPRI link with the subordinate RE.

When the CPRI link with the subordinate RE is established at step S1809 (Yes at step S1809), the RE 120 starts PTP master operation (step S1810). Thus, the time synchronization using PTP is performed with the RE 120 serving as the PTP master, and the subordinate RE under the RE 120 serving as the PTP slave.

Next, the RE 120, judging whether or not a PTP synchronization completion notification has been received from the subordinate RE serving as the PTP slave (step S1811), waits until the PTP synchronization completion notification is received (No loop at step S1811). When the PTP synchronization completion notification is received (Yes at step S1811), the RE 120 stops the PTP master operation (step S1812), and terminates the series of processes.

In the case that the REs 120, 140, and so on are coupled in a cascading manner, the REs 120, 140, and so on are able to comes in clock synchronization with the REC 110 through a clock extracted from the CPRI. For this reason, even though the PTP operation is suspended after the PTP synchronization is established, it is possible to keep the state where the REs 120, 140, and so on are in time synchronization with the REC 110.

Note that in the case where the RE 120 has information indicating whether or not a subordinate RE is present under the RE 120, step S1807 may be excluded from the processing. In the case where a subordinate RE is present under the RE 120 all the time, steps S1807 and S1808 may be excluded from the processing.

Although the description has been provided for the PTP processing by the RE120, PTP processing by the RE 140 is the same, for example. Here, at step S1801, the RE 140 establishes the CPRI link with the RE 120. At step S1805, the RE 140 transmits the PTP synchronization completion notification to the RE 120.

(PTP Processing with Boundary Clock Performed by Base Station System According to Embodiment)

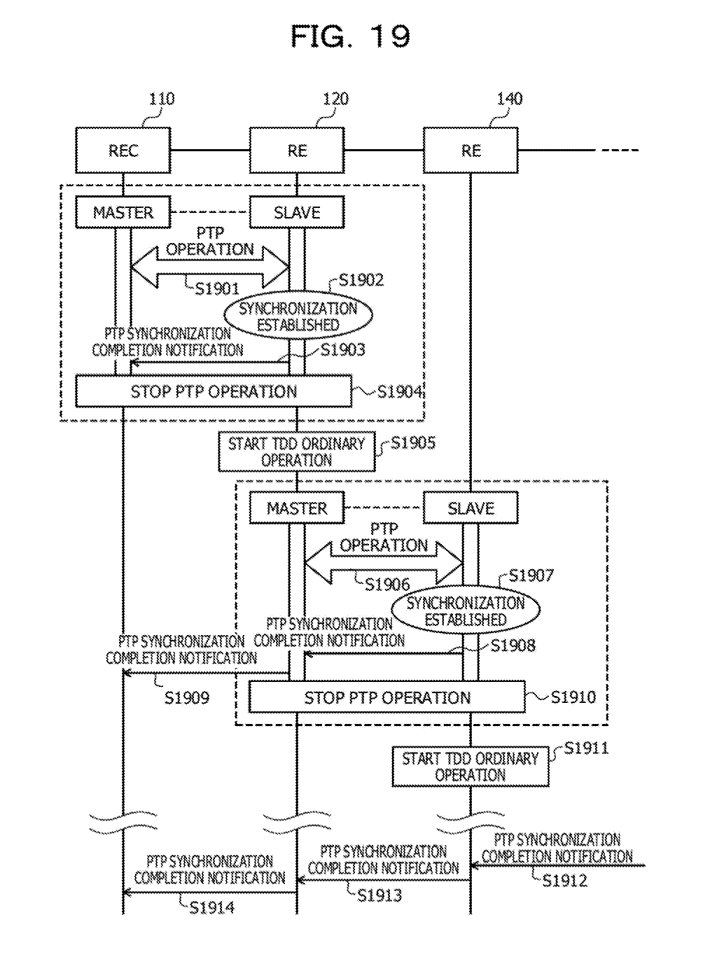

FIG. 19 is a sequence diagram illustrating an example of the PTP processing with the boundary clock performed by the base station system according to the embodiment In the case where the PTP processing with the boundary clock is performed with the REs 120, 140, and so on coupled to the REC 110 in a cascading manner, the REC 110 and the REs 120, 140, and so on execute, for example, each step illustrated in FIG. 19 as the PTP processing.

First, the PTP processing starts with the REC 110 serving as the PTP master, the RE 120 serving as the PTP slave (step $1901). Next, time synchronization is established (synchronization established) between the RE 120 and the REC 110 (step S1902).

Next, the RE 120 transmits a PTP synchronization completion notification to the REC 110 (step S1903). Next, the REC 110 and the RE 120 stop transmission and reception of each other's PTP packets to stop the PTP operation (PTP operation stop) that started at step S1901 (step S1904). Next, the RE 120 starts transmission and reception of a radio signal in time division duplex (TDD) (TDD ordinary operation start) (step S1905).

Next, the PTP operation starts with the RE 120 serving as the PTP master, the RE 140 serving as the PTP slave (step S1906). Next, in the RE 140, time synchronization with the RE 120 is established (synchronization established) (step S1907). Next, the RE 140 transmits a PTP synchronization completion notification to the RE 120 (step S1908). Next, the RE 120 transmits to the REC 110 the PTP synchronization completion notification received from the RE 140 at step S1908 (step S1909).

Next, the RE 120 and the RE 140 stop transmission and reception of each other's PTP packets to stop the PTP operation (PTP operation stop) that started at step S1906 (step S1910). Next, the RE 140 starts transmission and reception of a radio signal in TDD (TDD ordinary operation start) (step S1911).

In the case where still another subordinate RE is coupled under the RE 140, for example, the PTP processing such as from steps S1906 to S1910 is repeated in a cascading manner until the PTP processing reaches the distal RE. Then, as indicated by steps S1912 to S1914, when a PTP synchronization completion notification is transmitted from the distal RE to the REC 110, it is possible for the REC to judges that time synchronization is completed for all the REs under the REC 110.

As illustrated in FIG. 19, the REs 120, 140, and so on notify the REC 110 after controlling the current time to be synchronized with the REC 110 based on the time information acquired through transmission and reception of the PTP messages to and from the REC 110. The REs 120, 140, and so on receive a frame from the REC 110 in response to the notification.

(PTP Processing with Transparent Clock Performed by RE According to Embodiment)

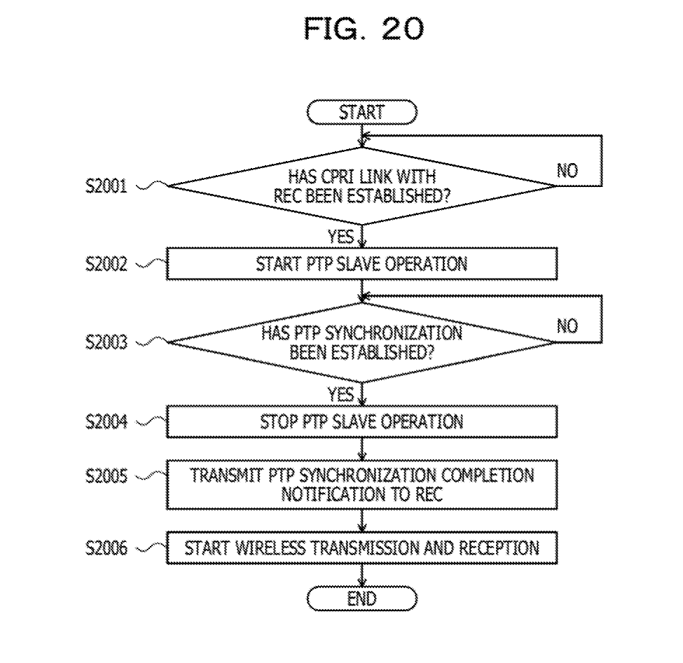

FIG. 20 is a flowchart illustrating an example of PTP processing with the transparent clock performed by the RE according to the embodiment. In the case where the PTP processing with the transparent clock is performed with the REs 120, 140, and so on coupled to the REC 110 in a cascading manner, each of the REs 120, 140, and so on executes, for example, each step illustrated in FIG. 20 as the PTP processing. Here, a description is provided for the PTP processing performed by the RE 120.

Steps S2001 to S2006 illustrated in FIG. 20 are the same as steps S1801 to S1806 illustrated in FIG. 18. When wireless transmission and reception start at step S2006, the RE 120 terminates the series of processes. Specifically, when the PTP processing with the transparent clock is performed, since the REC 110 serves as the master of the REs 120, 140, and so on, each of the REs 120, 140, and so on does not have to perform processing as a PTP master.

In the case where the REs 120, 140, and so on are coupled in a cascading manner, it is possible for the REs 120, 140, and so on to be in clock synchronization with the REC 110 using a clock extracted from the CPRI. Accordingly, after the PTP synchronization is established, even though the PTP operation is stopped, it is possible to keep the state where the REs 120, 140, and so on are in time synchronization with the REC 110.

Although the description has been provided for the PTP processing performed by RE 120, for example, PTP processing performed by the RE 140 is also the same. Here, at step S2001, the RE 140 establishes a CPRI link with the RE 120. At step S2005, the RE 140 transmits a PTP synchronization completion notification to the RE 120.

(PTP Processing with Transparent Clock Performed by Base Station System According to Embodiment)

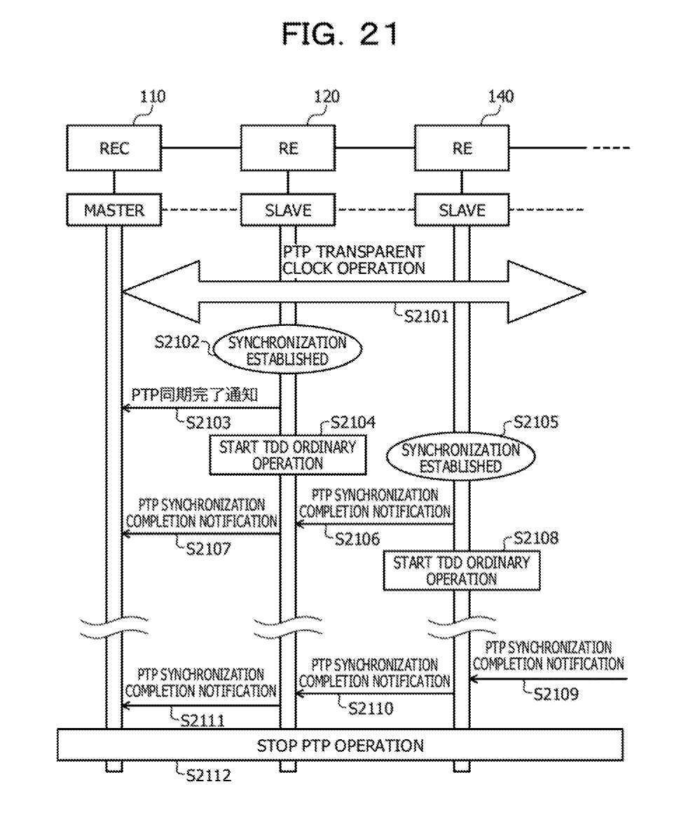

FIG. 21 is a sequence diagram illustrating an example of the PTP processing with the transparent clock performed by the base station system according to the embodiment. In the case where the PTP processing with the transparent clock is performed with the REs 120, 140, and so on coupled to the REC 110 in a cascading manner, the REC 110 and the REs 120, 140, and so on execute, for example, each step illustrated in FIG. 21 as the PTP processing. In the example Illustrated in FIG. 21, the PTP transparent clock operation starts with the REC 110 serving as the PTP master, the REs 120, 140, and so on serving as the PTP slaves (step S2101).

Next, in the RE 120, the time synchronization is established (synchronization established) with the REC 110 (step S2102). Next, the RE 120 transmits a PTP synchronization completion notification to the REC 110 (step S2103). Next, the RE 120 starts transmission and reception of a radio signal in TDD (TDD ordinary operation) (step S2104).

In the RE 140, the time synchronization is established (synchronization established) with the REC 110 (step S2105). Next, the RE 140 transmits a PTP synchronization completion notification to the RE 120 (step S2106). Next, the RE 120 transmits to the REC 110 the PTP synchronization completion notification received from the RE 140 at step S2106 (step S2107). Next, the RE 140 starts transmission and reception of a radio signal in TDD (TDD ordinary operation) (step S2108).

In the case where still another subordinate RE is coupled under the RE 140, the PTP processing such as steps S2105 and S2108, for example, is repeated to the distal RE. Then, as indicated in steps S2109 to S2111, when a PTP synchronization completion notification from the distal RE is transmitted to the REC 110, it is possible for the REC 110 to judges that the time synchronization is completed for all the REs under the REC 110. From this result, the REC 110 and the REs 120, 140, and so on stop transmission and reception of one another's PTP packets to stop the PTP operation (PTP operation stop) (step S2112).

As illustrated in FIG. 21, after the REs 120, 140, and so on notify the REC 110 after controlling the current time to be synchronized with the REC 110 based on the time information acquired through transmission and reception of the PTP messages to and from the REC 110. The REs 120, 140, and so on receive a frame from the REC 110 in response to the notification.

(Coupling Method for REs According to Embodiment)

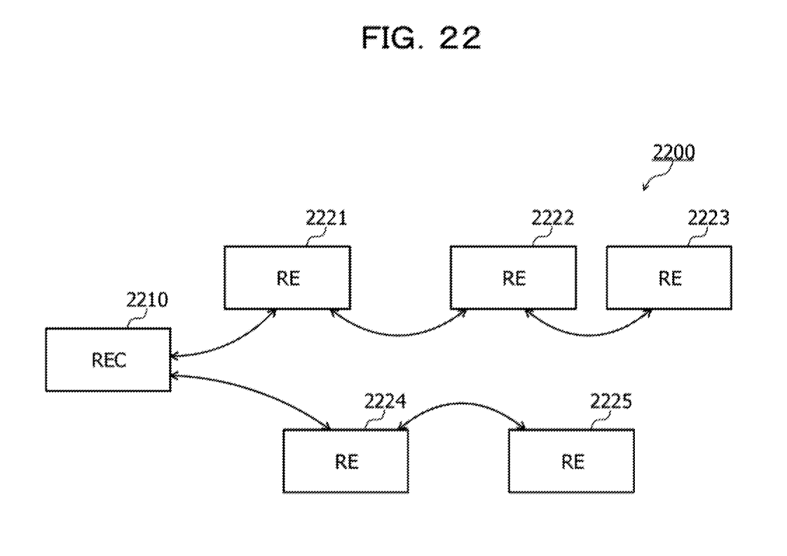

FIG. 22 is a diagram illustrating an example of a coupling method for the RE according to the embodiment. The base station system 100 illustrated in FIG. 1 is applicable, for example, to a base station system 2200 illustrated in FIG. 22. The base station system 2200 includes an REC 2210 and REs 2221 to 2225. In this configuration, the REC 2210 corresponds to the REC 110 of the base station system 100, and the REs 2221 to 2225 correspond to the REs 120, 140, and so on of the base station system 100.

In the base station system 2200, the REs 2221 and 2224 are coupled to the REC 2210. The REs 2222 and 2223 are coupled in series with the RE 2221. The RE 2225 is directly coupled to the RE 2224.

In the case where the REs 2221 to 2225 are coupled in a chain configuration as the example illustrated in FIG. 22, delay fluctuations (phase errors) of the CPRI frames that have reached the distal REs (for example, REs 2223 and 2225) are large. Meanwhile, also in the case where the REs 2221 to 2225 are coupled in a ring configuration instead of the chain configuration, for example, by coupling the RE 2223 and the RE 2225 with each other, delay fluctuations of the CPRI frames that have reached REs distant from the base station system 2200 are large.

However, applying the base station system 100 according to the embodiment to the base station system 2200 makes it possible to perform a delay correction to the IQ data at the REs 2221 to 2225 using the PTP synchronization even though the CPRI frames have delay fluctuations. This makes it possible for the REs 2221 to 2225 to match the radio signal transmission timings.

(Another Example of Coupling Method for RE According to Embodiment)

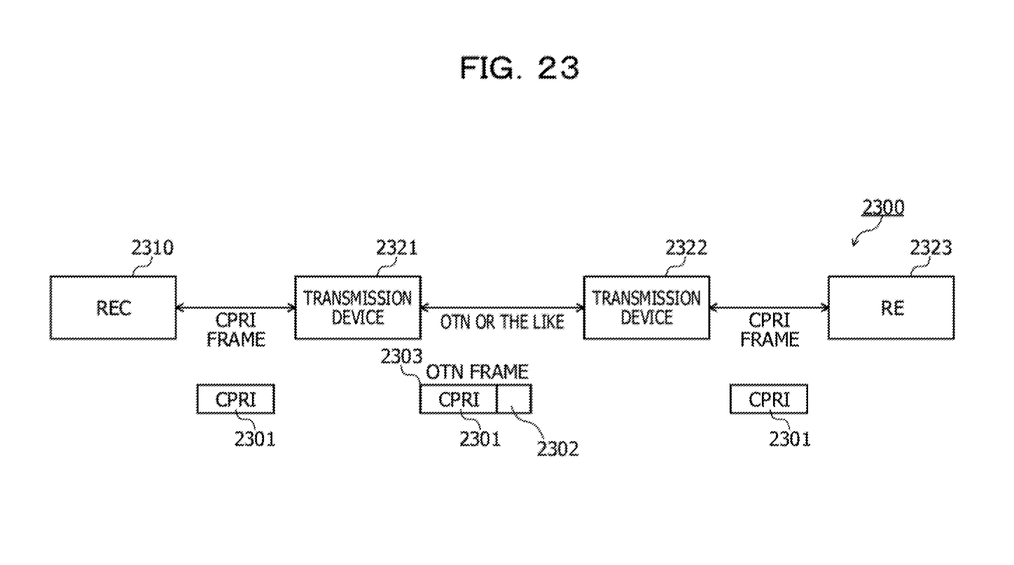

FIG. 23 is a diagram illustrating another example of the coupling method for the RE according to the embodiment. The base station system 100 illustrated in FIG. 1 may be applied to a base station system 2300 illustrated in FIG. 23. The base station system 2300 includes an REC 2310, transmission devices 2321 and 2322, and an RE 2323. In this configuration, the REC 2310 corresponds the REC 110 of the base station system 100, and the RE 2323 corresponds to the REs 120, 140, and so on of the base station system 100.

In the base station system 2200, the REC 2310 and the RE 2323 are coupled to each other through the transmission devices 2321 and 2322 that transmit using an optical transport network (OTN) or the like.

For example, the REC 2310 transmits to the transmission device 2321 a CPRI frame 2301 including IQ data to be wirelessly transmitted by the RE 2323. The transmission device 2321 transmits to the transmission device 2322 an OTN frame 2303 in which the control information 2302 is added to the CPRI frame 2301 received from the REC 2310. The transmission device 2322 extracts the CPRI frame 2301 from the OTN frame 2303 received from the transmission device 2321 and transmits the extracted CPRI frame 2301 to the RE 2323.

As the example illustrated in FIG. 23, in the configuration in which the REC 2310 and the RE 2323 are coupled to each other through the transmission devices 2321 and 2322, delay fluctuations of the CPRI frame 2301 may occur because of delay fluctuations caused in the transmission devices 2321 and 2322.

However, even though the CPRI frame has delay fluctuations, it is possible to perform the delay correction to the IQ data using the PTP synchronization at the RE2323. This makes it possible to match the radio signal transmission timing of the RE 2323 and the radio signal transmission timings of other REs. Note that other REs may be subordinate REs under the REC 2310 or REs that are not subordinate under the REC 2310.

(Another Example of Base Station System According to Embodiment)

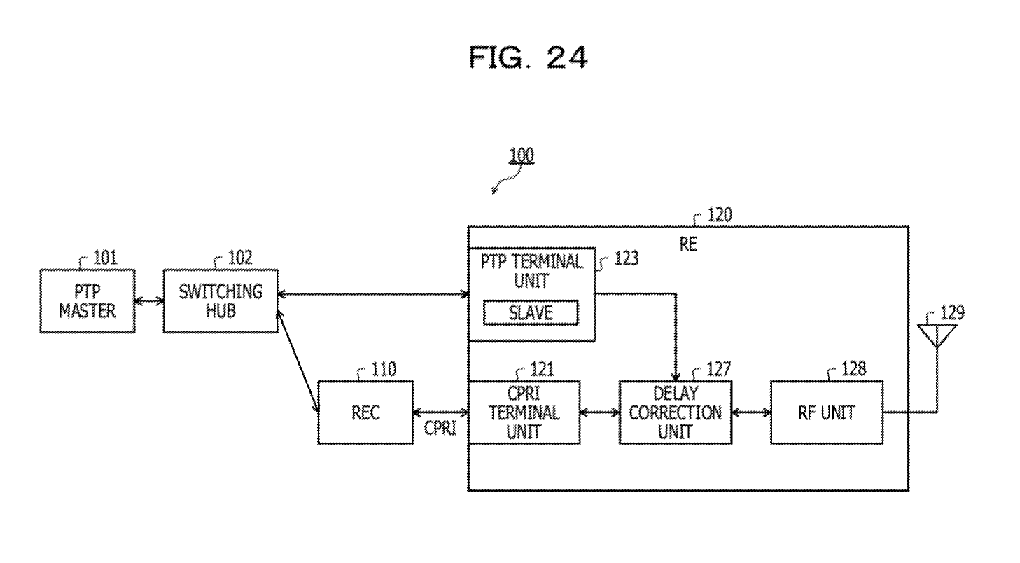

FIG. 24 is a diagram illustrating another example of the base station system according to the embodiment. In the FIG. 24, the same units as those in FIG. 1 are denoted by the same reference signs, and descriptions thereof are omitted. In the example illustrated in FIG. 1, a description has been provided for the configuration in which the REs 120 and 140 come into time synchronization with the PTP master 101, with which the REC 110 is in time synchronization, by transmitting and receiving PTP packets to and from the REC 110.

In contrast, in the example illustrated in FIG. 24, the RE 120 is coupled to the PTP master 101 without going through the REC 110. Note that in FIG. 24, illustration of a part of the configuration of the RE 120 is omitted. In this case, the PTP terminal unit 123 of the RE 120 comes in time synchronization with the PTP master 101, with which the REC 110 is in time synchronization, by directly receiving a PTP packet from the PTP master 101 through the switching hub 102. This makes it possible for the RE 120 to come into time synchronization also with the REC 110. Specifically, the PTP packet that the RE 120 receives from the PTP master 101 serves as a synchronization signal for the RE 120 to come into time synchronization with the REC 110.

As illustrated in FIG. 24, instead of using the PTP synchronization with the REC 110, the RE 120 may perform the delay correction to the IQ data to be wirelessly transmitted using the PTP synchronization with the PTP master 101, with which the REC 110 is in synchronization. Although the description has been provided for the RE 120, the RE 140 and so on may also perform the PTP synchronization with the PTP master 101 in the same manner.

As described above, it is possible for the RE 120 according to the embodiment to operate as the PTP slave when transmitting and receiving a PTP message to and from the REC 110 operating as the PTP master. It is also possible for the RE 120 to perform control such that the current time comes in synchronization with the REC 110, which operates as the PTP master, based on the time information acquired through transmission and reception of the PTP message to and from the REC 110. Then, the RE 120 generates a timing for wireless transmission based on the current time brought in synchronization with the REC 110, receives a frame including data to be wirelessly transmitted from the REC 110, and stores the data into the buffer. The RE 120 also controls the timing for the wireless transmission by reading the data from the buffer in accordance with a phase difference (phase gap) between the generated timing for the wireless transmission and a timing based on the reception of the frame from the REC 110. Although the description has been provided for the RE 120, the RE 140 and so on are the same. This makes it possible for each of the REs 120, 140, and so on to bring the wireless transmission timing of data in agreement with those of other REs.

in addition, the REs 120, 140, and so on may perform TDD to switch reception between a radio signal of the data and a signal that is wirelessly transmitted from another base station system (for example, a radio terminal), which is different from the base station system 100, at the PTP timing based on the PTP processing described above. This makes it possible for each of the REs 120, 140, and so on to bring the switching timing of transmission and reception of the radio signal in agreement with those of other REs.

Although in the embodiment described above, the description has been provided for the time synchronization with the transparent clock or the boundary clock as time synchronization using PTP, time synchronization using PTP is not limited thereto. For example, as time synchronization using PTP, time synchronization of a through method, in which a synchronization correction is not performed at relay devices, may be used.

As described above, according to the radio device and the base station system, it is possible to bring the wireless transmission timing of data in agreement with those of other radio devices.

For example, as a countermeasure against rapidly increasing radio traffic, for example, a small cell solution using TDD method has been undertaken in recent years. In TDD method, the radio frame output timing at an output antenna of each radio base station device has to agree with those of the other radio base station devices, and the switching timing of transmission and reception has to agree between the radio base station devices. To this end, the reference clocks and the reference timings of the radio base station devices have to be synchronized with high accuracy.

As an example, in ITU-T, a gap inside a network has to be within 1100 [ns]; a gap between the network and an REC, 250 [ns]; a gap between the REC and REs, 150 [ns]. The total gap has to be within 1500 [ns]. Note that ITU-T stands for International Telecommunication Union-Telecommunication sector.

As a method for synchronization between an REC and REs, there is a method of extracting a reference clock and a reference timing from a CPRI transmission path. Meanwhile, for the coupling between an REC and REs, not only directly coupling the REC and the RE with each other, there may be configurations in which the REC and REs are coupled through network apparatuses such as OTN, or in which the CPRI is coupled in a ring shape or in a cascading manner (for example, FIGS. 22 and 23).

In such configurations, there may be occurrence of delay time fluctuations at each device coupled in-between, a gap between a nominal value (calculated value) and an actual value for delay time of each device coupled in-between, a difference of delay time between on uplink and on downlink, and other variations. These fluctuations and gaps of delay time, accumulated at every device in a route, may sometimes cause a large gap in reference timings of the distal REs.

Meanwhile, there has been conventionally known a method in which an REC measures the transmission delay amount between the REC and an RE after establishing a CPRI link between the REC and the RE, and in which transmission phase adjustment for the CPRI frame is performed using the measurement result to control output timings of the REs. However, in this method, when a CPRI transmission phase is changed, the CPRI link is cut off, and large fluctuations occur in the CPRI link during startup. This causes a problem that link establishment is late.

In the case where the REs are coupled in a ring shape or in a cascading manner with this method, output timings of the REs are brought in agreement with each other by upstream REs delaying radio output timings of each device to agree to output timings of downstream REs. For this reason, the REs also have to have a delay correction function equivalent to that of the REC. This causes a problem that the delay correction function of REs becomes complicated, increasing the circuit scale of the REs.

In contrast, according to the embodiment described above, the PTP function is also provided for REs of a base station system (radio base station device), and the REs are capable of performing delay correction to a radio signal received from an REC through CPRI in such a way to be matched with a reference timing generated from PTP before wirelessly transmitting the corrected signal. This makes it possible to reduce delay errors in CPRI transmission paths and improve accuracy of the output timing of the radio frame. In addition, it is also possible for the REs to improve timing accuracy of switching transmission and reception of TDD by switching at the reference timing generated from PTP.

In addition, the clock extracted from the CPRI transmission path may be used as the system clock, for the wireless transmission and reception reference clock and the clock for the CPRI interfaces between the REC and the subordinated REs, except a clock used for generating the reference timing of the wireless transmission and reception. This makes it possible to reduce clock fluctuations.

In addition, for example, by performing delay correction at the REs with high accuracy (correction within a chip) using timings generated from the PTP time information, it is possible to degrade accuracy of delay correction at the REC or remove the delay correction at the REC. This makes it possible to bring the transmission timings of wireless transmission in agreement with each other without phase adjustment of the CPRI frame at the REC. Thus, it is possible to avoid a delay in establishing the CPRI link that might be caused by adjusting a transmission phase of the CPRI frame.

In addition, also in the case where the REs are coupled in a ring shape or in a cascading manner, it is possible for the REC to perform a rough delay correction based on the delay time of each RE, and for each RE to perform a minute delay correction based on the reference timing generated from PTP. This makes it possible to lighten the delay correction processing at each RE and reduce the circuit scale of the REs.

In addition, in the case where the PTP processing with the transparent clock is performed in the REC and the REs, it is possible to improve accuracy of the PTP time information by imparting delay information at the CPRI terminal unit to PTP.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A base station system comprising:
a radio control device that performs baseband processing; and
a radio device that is coupled to the radio control device through a transmission path, wherein
the radio control device includes
a first memory, and
a first processor coupled to the first memory and configured to:
transmit first time information and data to the radio device,
the radio device includes
an antenna,
a second memory, and
a second processor coupled to the second memory and configured to:
receive the first time information and the data,
generate second time information synchronized with the first time information based on the first time information transmitted from the radio control device,
store the data into a buffer,
identify, based on the second time information, a first timing when the data is to be transmitted from the antenna,
identify, based on a difference between the first timing and a second timing specified based on a system clock recovered from the received data, a third timing when the data is to be read from the buffer,
read the data stored in the buffer at the identified third timing.

2. The base station system according to claim 1, wherein
the radio control device is a precision time protocol (PTP) master device, and
the radio device is a PTP slave device.

3. The base station system according to claim 1, wherein
the second processor is further configured to transmit a notification Indicating that synchronization of the second time information with the first time information is established, to the radio control device, and
the first processor is configured to transmit the data to the radio device based on reception of the notification.

4. The base station system according to claim 1, wherein
the second processor is further configured to switch between first processing to transmit the data from the antenna and second processing to receive a signal transmitted from another base station system, based on the second time information.

5. The base station system according to claim 1, wherein
the second processor is further configured to identify the first timing based on the first time information and a clock generated based on the data.

6. The base station system according to claim 1, wherein
the first processor is further configured to identify a fourth timing to transmit the data to the radio device in accordance with a transmission delay amount that occurs between the radio control device and the antenna.

7. A radio device coupled to a radio control device through a transmission path, the radio control device being configured to perform baseband processing, the radio device comprising:
an antenna;
a memory; and
a processor coupled to the memory and configured to:
receive first time information and data transmitted from the radio control device,
generate second time information synchronized with the first time information based on the first time information,
store the data into a buffer,
identify, based on the second time information, a first timing when the data is to be transmitted from the antenna,
identify, based on a difference between the first timing and a second timing specified based on a system clock recovered from the received data, a third timing when the data is to be read from the buffer,
read the data stored in the buffer at the identified third timing.

8. The radio device according to claim 7, wherein
the radio control device is a precision time protocol (PTP) master device, and
the radio device is a PTP slave device.

9. The radio device according to claim 7, wherein
the processor is further configured to transmit a notification indicating that synchronization of the second time information with the first time information is established, to the radio control device, and
the radio control device is configured to transmit the data to the radio device based on reception of the notification.

10. The radio device system according to claim 7, wherein
the processor is further configured to switch between first processing to transmit the data from the antenna and second processing to receive a signal transmitted from another base station system, based on the second time information.

11. The radio device system according to claim 7, wherein
the processor is further configured to identify the first timing based on the first time information and a clock generated based on the data.

12. The radio device according to claim 7, wherein
the radio control device is further configured to identify a fourth timing to transmit the data to the radio device in accordance with a transmission delay amount that occurs between the radio control device and the antenna.

13. A method of data transmitting using a base station system including a radio control device that performs baseband processing and a radio device that is coupled to the radio control device through a transmission path, the method comprising:
transmitting, from the radio control device to the radio device, first time information and data;
generating, by the radio device, second time information synchronized with the first time information based on the first time information;
storing the data into a buffer included in the radio device;
identifying, by the radio device, based on the second time information, a first timing when the data is to be transmitted from an antenna included in the radio device;
identifying, by the radio device, based on a difference between the first timing and a second timing specified based on a system clock recovered from the received data, a third timing when the data is to be read from the buffer;
reading the data stored in the buffer at the identified third timing; and
transmitting, from the antenna, the data read from the buffer.

14. The method according to claim 13, wherein
the radio control device is a precision time protocol (PTP) master device, and
the radio device is a PTP slave device.

15. The method according to claim 13, further comprising:
transmitting, form the radio device to the radio control device, a notification Indicating that synchronization of the second time information with the first time information is established, wherein
the radio control device transmits the data to the radio device based on reception of the notification.

16. The method according to claim 13, further comprising:
switching, by the radio device, between first processing to transmit the data from the antenna and second processing to receive a signal transmitted from another base station system, based on the second time information.

17. The method according to claim 13, further comprising:
identifying, by the radio device, the first timing based on the first time Information and a clock generated based on the data.

18. The method according to claim 13, further comprising:
identifying, by the radio control device, a fourth timing to transmit the data to the radio device in accordance with a transmission delay amount that occurs between the radio control device and the antenna.
